(19) United States
(12) Patent Application Publication
(10) Pub. No.: US 2009/0214413 A1
(43) Pub. Date: Aug. 27, 2009

(54) ORDERED MESOPOROUS CARBONS AND METHOD FOR MANUFACTURING SAME

(76) Inventors: William P. Addiego, Big Flats, NY (US); Adra S. Baca, Pittsford, NY (US); Steven B. Dawes, Corning, NY (US); Wageesha Senaratne, Horseheads, NY (US)

Correspondence Address: CORNING INCORPORATED, SP-TI-3-1, CORNING, NY, 14831, US

(21) Appl. No.: 12/427,393

(22) Filed: Apr. 21, 2009

Related U.S. Application Data
(62) Division of application No. 11/899,002, filed on Aug. 31, 2007.
(60) Provisional application No. 60/876,274, filed on Dec. 21, 2006.
(60) Provisional application No. 60/925,997, filed on Apr. 24, 2007.

(51) Int. Cl. C01B 31/08

(52) U.S. Cl. 423/460; 423/445 R

(57) ABSTRACT

The present invention relates to an ordered mesoporous carbon and method for manufacturing the ordered mesoporous carbon which is made from a surfactant, a carbon precursor, water (possibly mixed with an acid) and a water immiscible oil. In addition, the present invention relates to a method of formulating a composition which is used to manufacture the ordered mesoporous carbon. Moreover, the present invention relates to an activated carbon which is made by partially oxidizing an ordered mesoporous carbon.

### CROSS-REFERENCE TO RELATED APPLICATIONS

This is a divisional of U.S. patent application Ser. No. 11/899,002 filed on Aug. 31, 2007, the content of which is relied upon and incorporated herein by reference in its entirety, and the benefit of priority under 35 U.S.C. § 120 is hereby claimed.

### CLAIMING BENEFIT OF PRIOR FILED U.S. APPLICATION

This application claims the benefit of U.S. Provisional Application Ser. Nos. 60/876,274 (filed on Dec. 21, 2006) and 60/925,997 (filed on Apr. 24, 2007). The contents of these documents are hereby incorporated by reference herein.

### TECHNICAL FIELD

The present invention relates to the formation of an ordered mesoporous carbon by using a surfactant/carbon precursor-water/oil system which leads to an enhanced control and flexibility over the phase domain, the mesoporous structure, the mesopore size and the macroscale morphology of the resulting mesoporous carbon material. In one embodiment, the ordered mesoporous carbon is partially oxidized to form an activated carbon on which for example a catalyst can be dispersed and stabilized.

### BACKGROUND

The synthesis of ordered mesoporous carbons has been the subject of a considerable amount of research in recent years because of their use in a wide variety of applications. For instance, ordered mesoporous carbons can be used in applications related to water/air purification, gas separation, catalysis, adsorption of large hydrophobic molecules, chromatographic separations, capacitive deionization, electrochemical double-layer capacitors, and hydrogen storage.

The ordered mesoporous carbons (which have built-in three-dimensionally (3-D) ordered/interconnected pore arrangements) can be made by using any one of two synthesis techniques. In the first technique, the ordered mesoporous carbons are made by preparing an inorganic silica template, impregnating the silica template with a carbon precursor, drying the impregnated silica template, cross-linking the impregnated silica template, and carbonizing the cross-linked silica template where the silica template is dissolved to leave the ordered mesoporous carbon. For instance, the silica templates can have different structures such as MCM-48, SBA-15, and SBA-16 which can be used to prepare carbon replicas called CMK-1,6 CMK-3,7 and CMK-6,8, respectively. Even though the resulting carbon structure is preprogrammed through the parent silica template, this synthesis technique is still time consuming and costly.

The second synthesis technique which has received most of attention recently involves the use of organic-organic composites including an organic template. In one version of this synthesis technique, the ordered mesoporous carbons are made by self-assembling an organic template, impregnating the organic template with a carbon precursor, drying the impregnated organic template, cross-linking the impregnated organic template, and carbonizing the cross-linked organic template where the organic template is dissolved to leave the ordered mesoporous carbon (note: the self-assembling and impregnating of the organic template are performed at the same time and are thus considered as one manufacturing step). This particular technique avoids the use of an inorganic template and as such reduces the number of manufacturing steps. In a second version of the synthesis technique, an ordered mesoporous carbon powder is made by mixing in the organic template and the carbon precursor, and reacting them in a water rich environment till a precipitate is formed. Then, the powder is carbonized without a cross-linking step where the organic template is dissolved to leave the ordered mesoporous carbon (note: the self-assembling of the template with the carbon precursor results in a precipitate formation and this can only be used in a powder synthesis). Furthermore, since both of these versions of the second synthesis technique use an organic-organic system there is more flexibility towards controlling the phase orientation of the pores which are formed within the ordered mesoporous carbons. An improvement related to the second synthesis technique for manufacturing ordered mesoporous carbons is the subject of the present invention.

### SUMMARY

In one aspect, the present invention provides an ordered mesoporous carbon which is formed from a surfactant, water and carbon precursor solution and a water immiscible oil (and possibly an acid which is mixed with the water). In one embodiment, the ordered mesoporous carbon is manufactured by using the following steps: (a) mixing a solution containing at least a predetermined amount of a solvent and the desired amounts of the surfactant, the carbon precursor, the water and the oil (option: the water may contain an acid such as, for example, a mineral acid, HCl, HNO₃, H₂SO₄, H₃PO₄); (b) drying the solution; (c) cross-linking the solution to immobilize the water and form a pre-carbonized mesostructure phase (which includes a self-assembled organic template); and (d) carbonizing the pre-carbonized mesostructure phase to form the ordered mesoporous carbon (where the self-assembled organic template is dissolved to form the ordered mesoporous carbon). To help determine the desired amounts of the surfactant, the carbon precursor, the water (and possibly an acid) and the oil that are mixed in step (a) one could use a formulation method including the steps of: (1) selecting a well known surfactant/water/oil equilibrium phase diagram; (2) replacing the water phase label in the surfactant/water/oil equilibrium phase diagram with a carbon precursor and water phase label; and (3) using the surfactant/carbon precursor and water solution/oil equilibrium phase diagram as a guide to estimate the desired amount of the surfactant, the carbon precursor/water solution (and possibly an acid which is mixed with the water) and the oil which should be used to make the ordered mesoporous carbon.

In another aspect, the present invention provides an activated carbon which is made by partially oxidizing an ordered mesoporous carbon. In one embodiment, the activated carbon can be manufactured by using the following steps: (a) mixing a solution which contains a solvent and a predetermined amount of a non-ionic surfactant, a water-soluble carbon precursor/H₂O solution, and a water immiscible oil (option: the solution may contain a potassium compound such as, for example, potassium hydroxide, potassium acetate, potassium chloride, potassium nitrate, potassium sulfate or other potassium halides or the water may contain an acid such as, for example, a mineral acid, HCl, HNO₃, H₂SO₄, H₃PO₄); (b) drying the solution; (c) cross-linking the solution to immobilize the water and form a pre-carbonized mesostructure phase; (d) carbonizing the pre-carbonized mesostructure phase to remove a self-assembled surfactant template from therein so as to form an ordered mesoporous carbon; and (e) partially oxidizing the surface and at least a portion of the internal edges within channels/pores that open-up on the surface of the ordered mesoporous carbon so as to form the activated carbon.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIG. 1A is a flowchart illustrating the steps of a preferred method for manufacturing an ordered mesoporous carbon in accordance with the present invention;

FIG. 1B is a flowchart illustrating the steps of a preferred method for determining the desired amounts of surfactant, carbon precursor, water and oil that could be used to make the ordered mesoporous carbon in accordance with the present invention;

FIGS. 2-16 are various graphs, images and diagrams which are used to help explain the results of several experiments that were conducted to test ordered mesoporous carbons which were made by using the methods shown in FIGS. 1A-1B in accordance with the present invention;

FIG. 17 is a flowchart illustrating the steps of a preferred method for manufacturing an activated carbon (using an ordered mesoporous carbon) in accordance with another embodiment of the present invention; and

FIGS. 18-21 are various graphs, images and diagrams which are used to help explain the results of several experiments that were conducted to test activated carbons which were made by using the method shown in FIG. 17 in accordance with another embodiment of the present invention.

### DETAILED DESCRIPTION

The present invention includes an ordered mesoporous carbon which was formed from a surfactant, water and carbon precursor solution and a water immiscible oil (note: the water component may optionally contain an acid such as, for example, a mineral acid, HCl, HNO₃, H₂SO₄, H₃PO₄). The addition of the water immiscible oil expands the composition from a two phase to a three phase system, and also expands the range of surfactant/water and carbon precursor compositions for which a particular mesostructure is stable. The addition of the oil phase also helps one to tune the physical properties within a mesostructure such as pore volume and pore diameter.

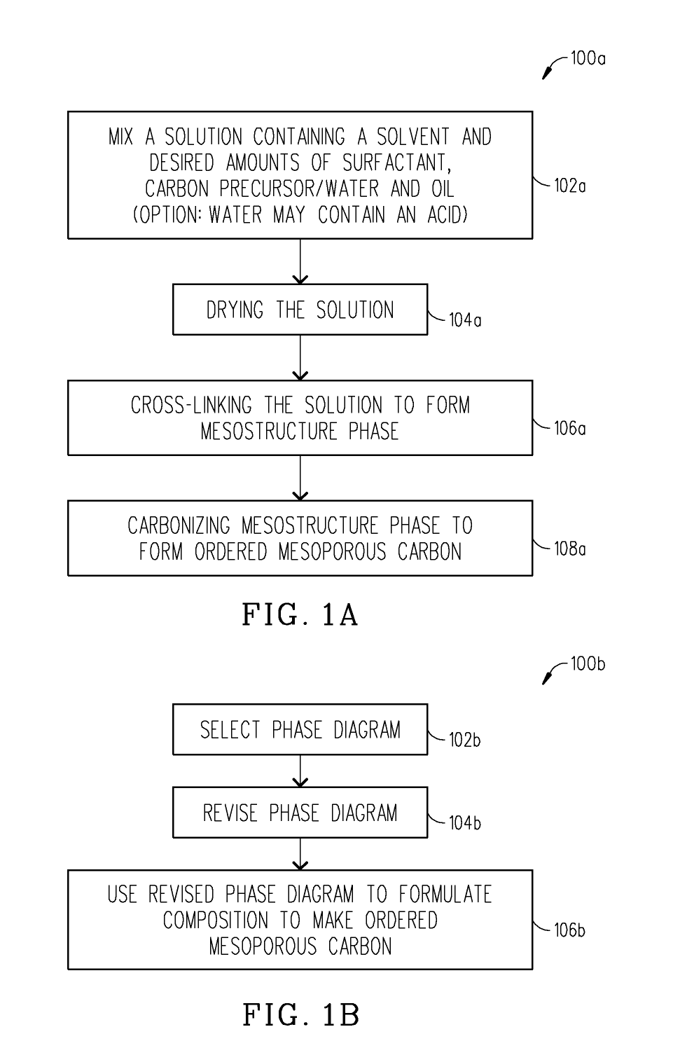

In one embodiment, the ordered mesoporous carbon can be formed by using a manufacturing method 100a which includes the following steps: (a) mixing a solution containing at least a predetermined amount of a solvent and the desired amounts of the surfactant, the carbon precursor, the water and the oil (step 102a in FIG. 1A) (option: the water may contain an acid such as, for example, a mineral acid, HCl, HNO₃, H₂SO₄, H₃PO₄); (b) drying the solution (step 104a in FIG. 1A); (c) cross-linking the solution to immobilize the water and form a pre-carbonized mesostructure phase (which includes a self-assembled organic template) (step 106a in FIG. 1A); and (d) carbonizing the pre-carbonized mesostructure phase to form the ordered mesoporous carbon (where the self-assembled organic template is dissolved to form the ordered mesoporous carbon) (step 108a in FIG. 1A). This method 100a could use an evaporation induced concentration of the surfactant/water and carbon precursor/oil phase to form the ordered mesostructure which could then be used to make for example thin films, coatings, free standing membranes, or powders.

In another aspect of the present invention, it has been discovered that well known surfactant/water/oil ternary systems equilibrium phase diagrams could be used to help estimate a composition/formulation of the surfactant/carbon precursor-water/oil that can be mixed together to make a desired ordered mesoporous carbon. Thus, there is another embodiment of the present invention which is related to a method 100b for determining the formulation/composition of the surfactant/carbon precursor-water/oil that could be mixed together to manufacture the ordered mesoporous carbon. The formulation method 100b includes the following steps: (1) selecting a surfactant/water/oil equilibrium phase diagram (step 102b in FIG. 1B); (2) replacing the water phase label in the surfactant/water/oil equilibrium phase diagram with a carbon precursor and water phase label (step 104b in FIG. 1B); and (3) using the surfactant/carbon precursor and water solution/oil equilibrium phase diagram as a guide to estimate a desired amount of surfactant, carbon precursor/water solution and oil which should be used to make the ordered mesoporous carbon (step 106b in FIG. 1B). This particular formulation of the surfactant, carbon precursor/water solution and oil is what is used in the mixing step 102a of the manufacturing method 100a (see FIG. 1A). A detailed discussion is provided next to further explain the individual steps of methods 100a and 100b and to further explain several experiments which were conducted to verify the usefulness of the manufacturing method 100a and the formulating method 100b.

In particular, the ordered mesoporous carbon is formed from a highly concentrated precursor solution of 1) a non-ionic surfactant, 2) a water-soluble carbon precursor/H₂O solution, and 3) an oil (cosurfactant) which is dried and cross-linked to form surfactant based self-assemblies in which the carbon precursor stabilizes the mesostructure phase (steps 108, 110 and 112). The formed mesostructure phase is then transformed by carbonization into the ordered mesoporous carbon with the removal of the surfactant-based self-assembled organic template (step 114). The precursor solution has three components including a surfactant, carbon precursor-water, and oil with a specific volume ratio preferably based on a well known and documented surfactant/water/oil equilibrium phase diagram which has been revised in accordance with one embodiment of the present invention to be a surfactant/carbon precursor-water/oil equilibrium phase diagram.

To determine the volume ratio of the surfactant, carbon precursor-water and oil, one would select a well known and documented surfactant/water/oil equilibrium based phase diagram and then they would revise the selected phase diagram by replacing the water phase label with a water soluble carbon precursor/H₂O label to form a “new” surfactant/carbon precursor-water/oil equilibrium phase diagram (note 1: one could use their knowledge about making a lyotropic liquid crystal from a non-ionic surfactant to help select a surfactant/water/oil equilibrium based phase diagram) (note 2: the contents within the “new” surfactant/carbon precursor-water/oil equilibrium phase diagram phase diagram itself are not completely accurate due to the different hydrophilicity of the carbon precursor and water solution from pure water, so with some experience the phase boundaries could be estimated to obtain the desired ordered mesoporous carbon). Then, the “new” surfactant/carbon precursor+water/oil equilibrium based phase diagram is used as a guide to determine the volume ratios of the three components which are used to make the desired ordered mesoporous structures. There are several advantages associated with using a “new” surfactant/carbon precursor-water/oil equilibrium phase diagram as a guide to determine how much surfactant, carbon precursor-water and oil should be used to make the ordered mesoporous carbons. These advantages include (for example): the ability to select a particular phase such as 3D cubic (Im3m, Pm3m space group), 2D hexagonal (P6 mm), 3D hexagonal (P6₃/mmc), or lamellar; (2) enhanced control over the surfactant phase domains; (3) enhanced control over the pore size; and (4) enhanced control over the macroscale morphology. An example of how the present invention can be implemented is discussed next.

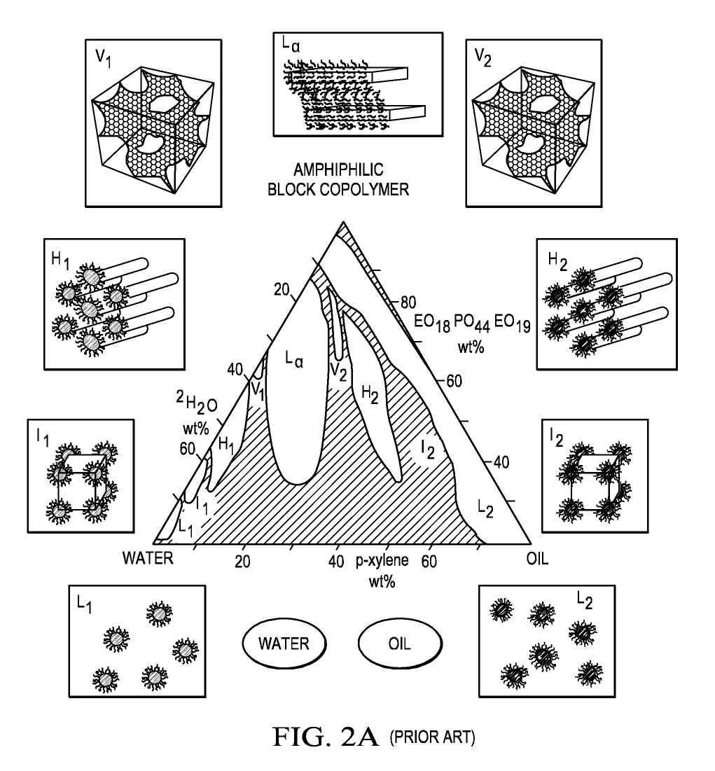

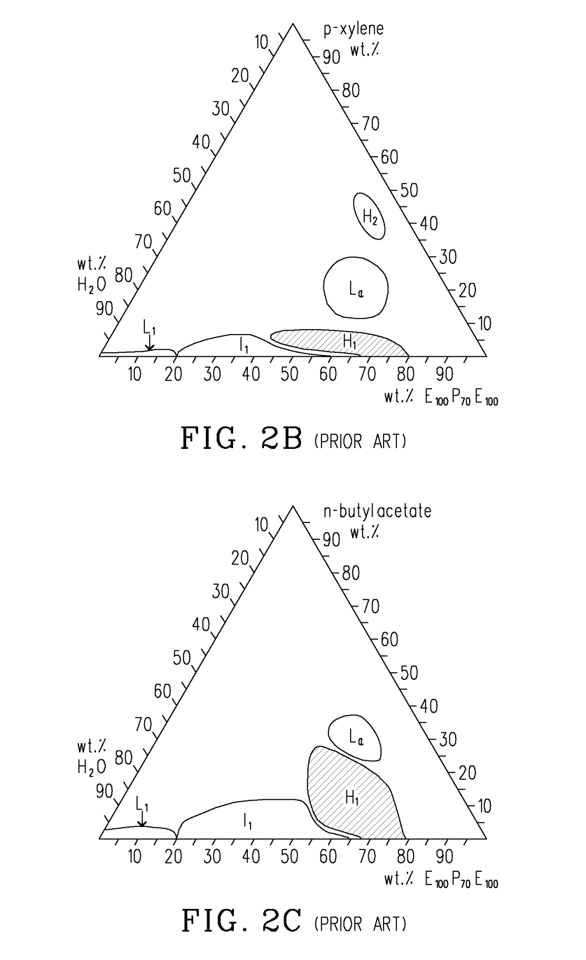

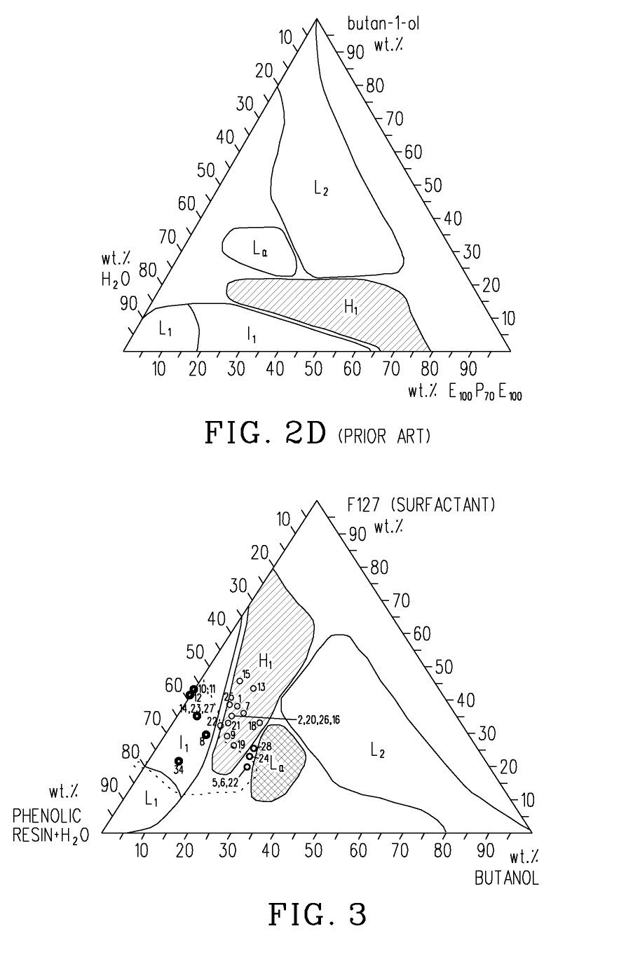

FIG. 2A (PRIOR ART) shows a well known equilibrium phase diagram for a PEOx-PPOy-PEOx (x=19, y=43)/H₂O/p-xylene ternary system at 25° C. This diagram shows various phases that can be obtained by using different wt % of the three components PEOx-PPOy-PEOx (x=19, y=43), H₂O and p-xylene (note: PEOx-PPOy-PEOx is a surfactant and p-xylene is an oil). The phase boundaries are drawn with solid lines where I1, H1, V1, Lα, V2, H2, and I2 are denoted as normal (oil-in-water) micellar cubic, normal hexagonal, normal bicontinuous cubic, lamellar, reverse (water-in-oil) bicontinuous cubic, reverse hexagonal, and reverse micellar cubic lyotropic liquid crystalline phases, respectively, while L1 and L2 respectively denote water-rich (normal micellar) and water-lean/oil-rich (reverse micellar) solutions. The diagram has been provided to illustrate some of the different phase orientations one could have in an ordered mesporous carbon.

FIGS. 2B-2D (PRIOR ART) show three well known equilibrium phase diagrams for three different PEOx-PPOy-PEOx (x=106, y=70 also known as Pluronic™ F127)/H₂O/oil ternary systems. These diagrams show the various changes that can take place with phase orientations by changing the oil component from p-xylene to butyl acetate to butanol. The I1, H1, Lα, H2, L1 and L2 respectively denote normal (oil-in-water) micellar cubic, normal hexagonal, lamellar, reverse hexagonal, water-rich (normal micellar) and water-lean/oil-rich (reverse micellar) solutions. These phase diagrams and other types of phase diagrams are well known and are readily available in literature (e.g., see P. Alexandridis et al. “A Record Nine Different Phases (Four Cubic, Two Hexagonal, and One Lamellar Lyotropic Liquid Crystalline and Two Micellar Solutions) in a Ternary Isothermal System of an Amphiphilic Block Copolymer and Selective Solvents (Water and Oil)” Langmuir 1998, 14, 2627-2638).

As discussed above, to synthesize the ordered mesoporous carbons of the present invention a carbon precursor based composition can be formulated with the aid of a well known surfactant/water/oil phase diagram. To accomplish this, the water phase in the well known surfactant/water/oil phase diagram is replaced with a water soluble carbon precursor/H₂O solution (note: the water weight % is used as equivalent to the carbon precurosor+water weight %. Then, the “new” surfactant/carbon precursor+water/oil phase diagram is used to help formulate a composition of (1) a non-ionic surfactant, (2) a water-soluble carbon precursor/H₂O solution, and (3) an oil.

FIG. 3 shows a “new” equilibrium phase diagram which was used in various experiments to formulate compositions that were used to form different ordered mesoporous carbons in accordance with the present invention. In this exemplary “new” surfactant/carbon precursor+water/oil phase diagram, the surfactant is PEOx-PPOy-PEOx (x=106, y=70 also known as Pluronic™ F127), the carbon precursor is phenolic resin and the oil is butanol (note: the “new” surfactant/carbon precursor+water/oil phase diagram is based on the well known surfactant/water/oil equilibrium based phase diagram shown in FIG. 2D). The dots represent the formulations which were tested where dots 1, 2, 7, 9, 13, 15, 16, 18-19, 20, 21, 22 and 25-26 represent the tested formulations in the 2D hexagonal phase (H1), the dots 3, 4, 10, 11, 12, 14, 23 and 27 represent the tested formulations in the cubic phase (I1), and the dots 5, 6, 22, 24 and 28 represent the tested formulations in the phase in between hex and lamellar (H1 and Lα). TABLE 1 list various details about these particular formulations along with the predicted phase/orientation (in view of the “new” surfactant/carbon precursor+water/oil equilibrium phase diagram) and the actual phase/orientation of the resulting ordered mesoporous carbons.

TABLE 1

| | weight % | | | | phase | |
|---|---|---|---|---|---|---|
| | | phenolic | butanol | ethanol | predicted | exper. |
| sample# | F127% | resin/water | % | (ML) | phase | phase |
| 1 | 36% | 52% | 12% | 20 | hex | hex |
| 2 | 35% | 53% | 12% | 20 | hex | hex |
| 3 | 20% | 72% | 7% | 10 | cubic | cubic |
| 4 | 20% | 72% | 7% | 10 | cubic | cubic |
| 5 | 21% | 55% | 24% | 12 | in b/w | cubic |
| | | | | | hex and | |
| | | | | | lamellar | |
| 6 | 21% | 55% | 24% | 12 | in b/w | cubic |
| | | | | | hex and | |
| | | | | | lamellar | |
| 7 | 35% | 50% | 15% | 19 | hex | hex |
| 8 | 28% | 61% | 10% | 18 | cubic | cubic |
| 9 | 27% | 59% | 14% | 16 | hex | hex |
| 10 | 39% | 61% | 0% | 23 | cubic | cubic |
| 11 | 38% | 62% | 0% | 23 | cubic | cubic |
| 12 | 38% | 62% | 0% | 23 | cubic | cubic |
| 13 | 42% | 46% | 12% | 23 | hex | no |
| | | | | | | order |
| 14 | 34% | 62% | 4% | 20 | cubic | cubic |
| 15 | 43% | 48% | 9% | 24 | hex | hex |
| 16 | 36% | 53% | 12% | 20 | hex | hex |
| 17 | 35% | 53% | *12% | 20 | hex | hex |
| 18 | 31% | 48% | 21% | 16 | hex | hex |
| 19 | 25% | 58% | 17% | 16 | hex | hex |
| 20 | 26% | 40% | 34% | 20 | lamellar | hex |
| 21 | 33% | 56% | 11% | 10 | hex | hex |
| 22 | 32% | 58% | 10% | 10 | border of | cubic |
| | | | | | hex | |
| 23 | 34% | 62% | 4% | 10 | cubic | cubic |
| 24 | 24% | 55% | 21% | 10 | in b/w | no |
| | | | | | hex and | order |
| | | | | | lamellar | |
| 25 | 37% | 52% | 12% | 10 | hex | no |
| | | | | | | order |
| 26 | 35% | 53% | 11% | 10 | hex | hex |
| 27 | 33% | 63% | 4% | 10 | cubic | hex |
| 28 | 24% | 54% | 21% | 10 | in b/w | hex |
| | | | | | hex and | |
| | | | | | lamellar | |

Note 1:
The water contains 1.6N HCl (acid) that is equal to approximately 0.2x surfactant weight.
Note 2:
The water used in formulations 3, 5, 10 and 12 did not contain an acid.

In these experiments, low angle X-ray diffraction (XRD) was used as the initial form of characterization to analyze and confirm the phase of the structure which was made using the particular formulations listed in TABLE 1. From the XRD data, all of the samples studied exhibited the phase predicted by the “new” phase diagram except for samples #s 24, 25 and 13 which showed no order, sample #28 which showed a 2D hexagonal order, and samples #s 5, 6 and 22 which showed a cubic structure. These results suggest that a “new” phase diagram can be used as a guide in working out the compositions for a required ordered mesoporous carbon structure but it may not always necessarily give the composition which results in a structure which has the predicted phase orientation. However, by using the compositions determined in view of the “new” phase diagram one can definitely map out regions/phase orientations of interest in a more systematic and a controlled manner. Selected ones of these sample compositions were tested in detail and the test results which include scanning electron micrographs (SEMS), pore volume distribution (PVD) and transmission electron micrographs (TEMs) are discussed next.

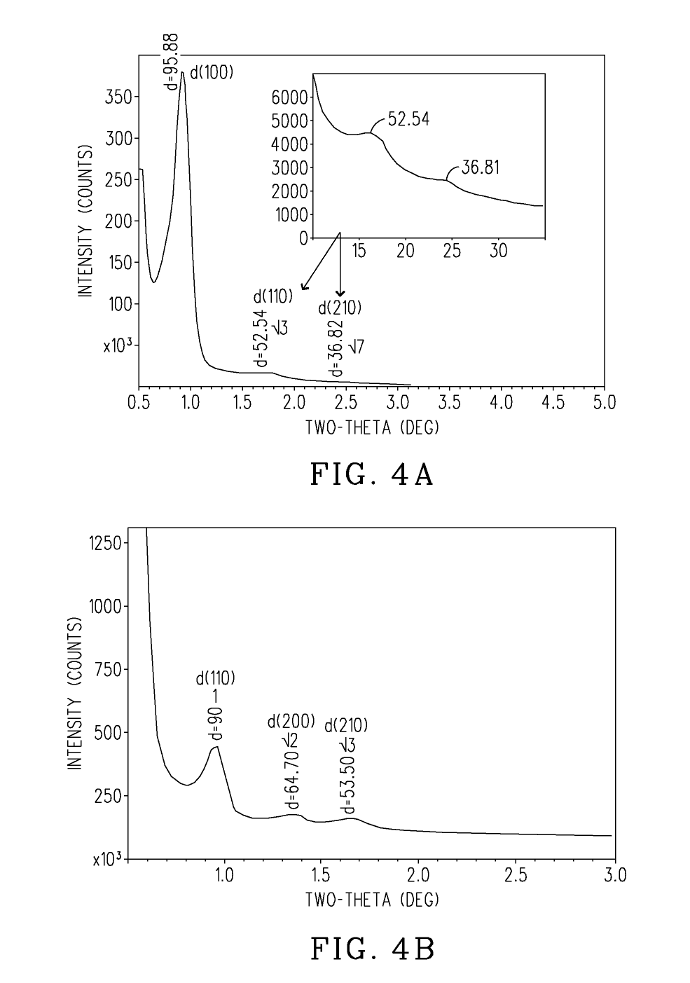

FIGS. 4A and 4B are two graphs that respectively illustrate the XRD data that was associated with sample #2 (which had a hexagonal geometry) and sample #3 (which had a cubic geometry). As can be seen, sample #2 had a intense well-resolved (100) peak at 96 Å with 2 higher order peaks of d(110) ˜52 Å and d(210) ˜37 Å at 1.7° and 2.4° two-theta respectively. The sample #3 had a well-resolved (110) peak at 91 Å with two higher order peaks at d(200) ˜64.7 and d(210) ˜53 Å. This data is consistent with what was predicted by using the “new” phase diagram shown in FIG. 3.

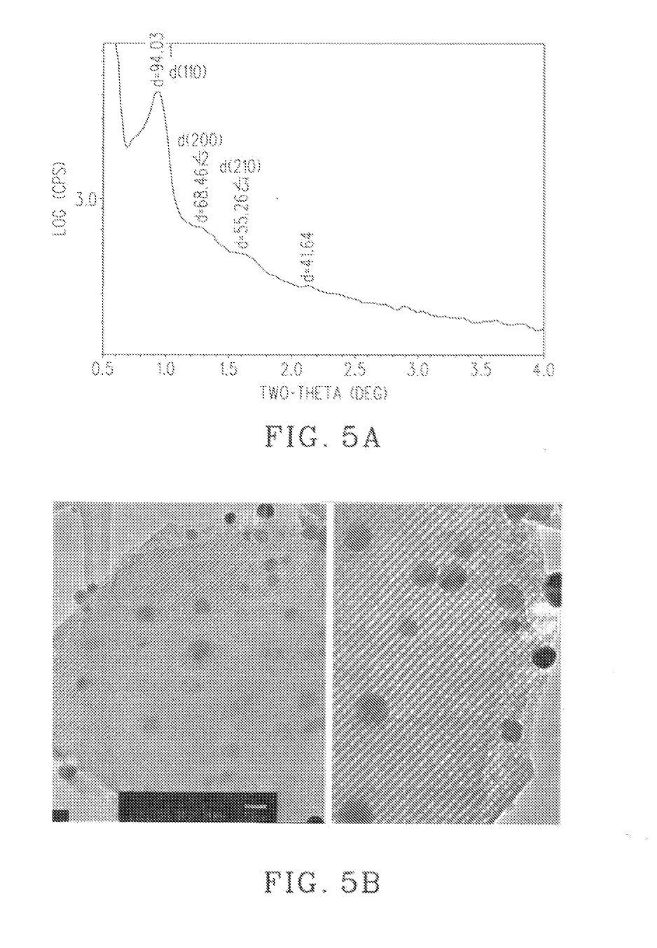

FIGS. 5A and 5B respectively illustrate a XRD graph and a TEM image associated with sample #6. As indicated in TABLE #1, sample #6 had a predicted geometry in between the hexagonal and lamellar phases that was based on the “new” phase diagram shown in FIG. 3. However, the tested sample #6 showed a well-resolved (110) peak at 94 Å with two higher order peaks at d(200) ˜68 and d(210) ˜55 Å which indicate cubic geometry. The TEM image confirmed that sample #6 did indeed have a cubic geometry. Again, the “new” phase diagram could be used as a guide to formulate the compositions to make an ordered mesoporous carbon structure but it may not always provide the composition which results in a structure having the predicted phase orientation.

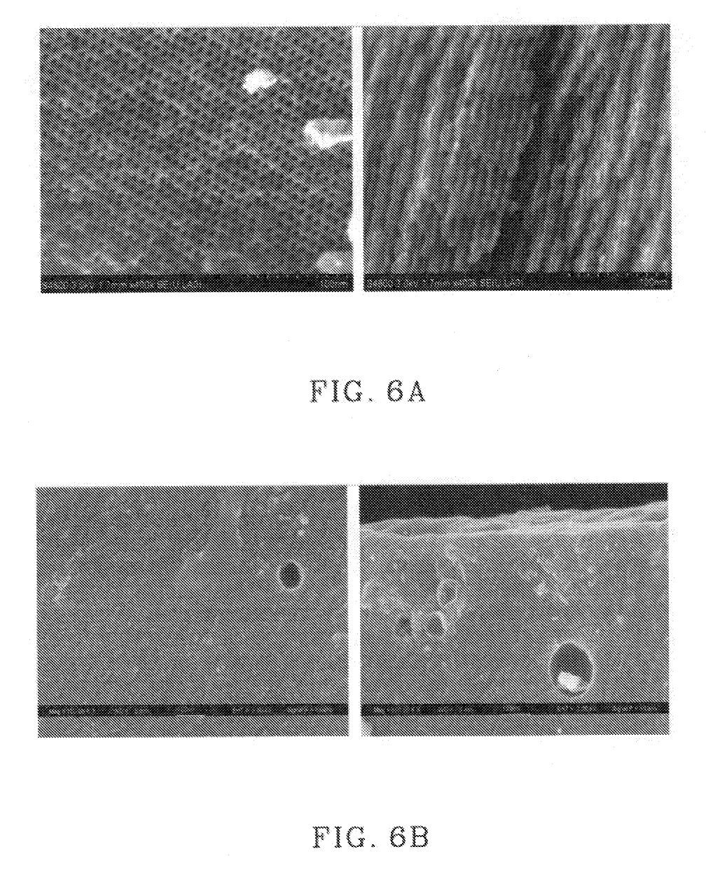

FIGS. 6A and 6B respectively illustrate SEMs for sample #2 and sample #6. As can be seen, the SEM of sample #2 shows a well resolved 2D hexagonal structure with 4.5 pore diameters and the SEM for sample #6 showed a cubic geometry (see also FIGS. 5A and 5B which were associated with sample #6).

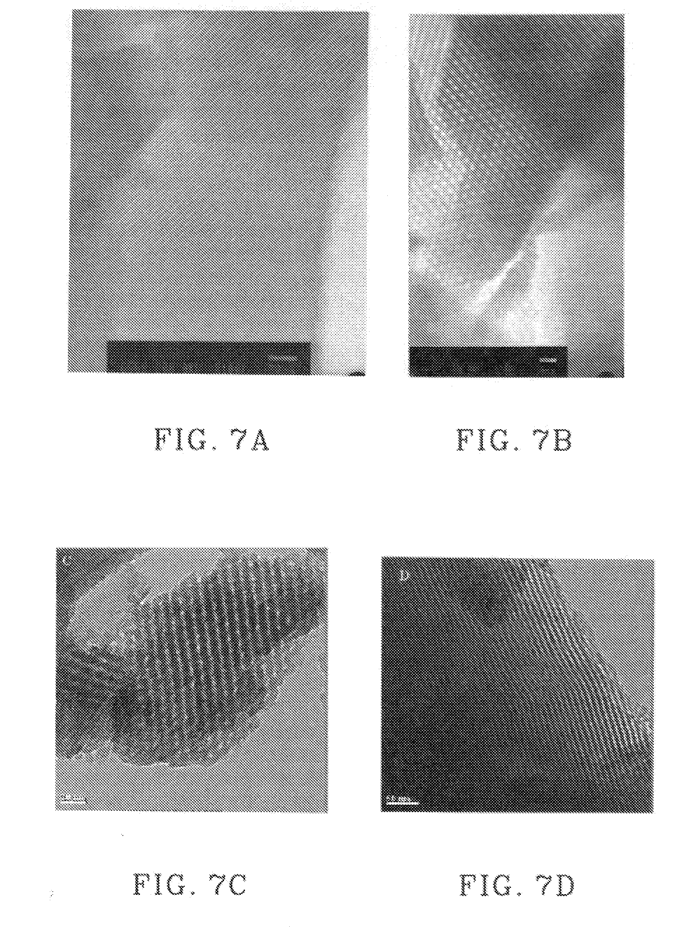

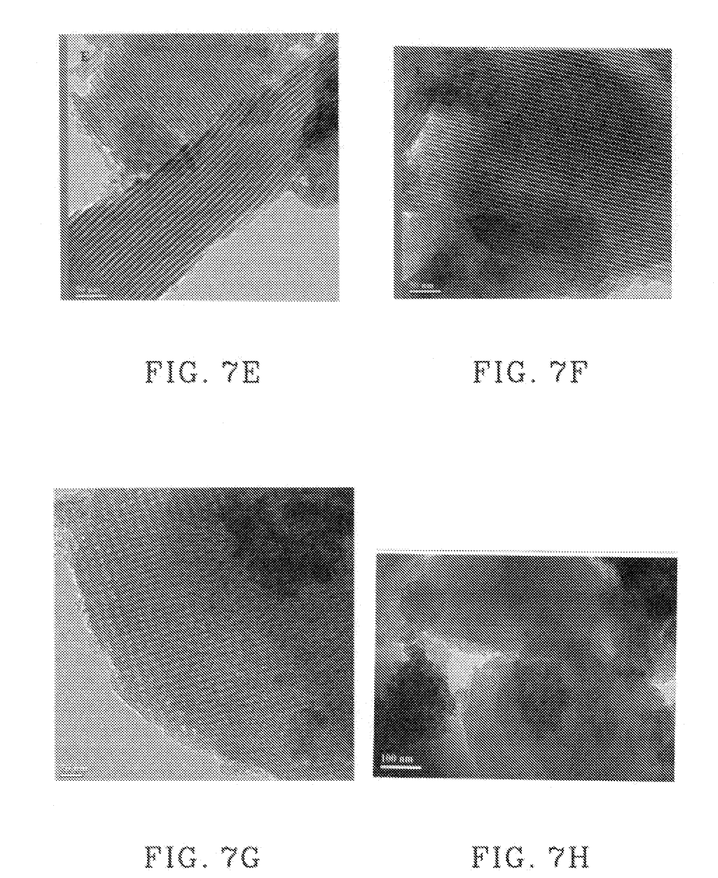

FIGS. 7A-7H illustrate TEM images associated with sample #s 2, 7, 20 and 8 (which were treated at 900° C.). As can be seen, sample #2 had a predicted and tested hexagonal geometry with 1-D channels [(110) plane] (see TEM in FIG. 7A) and a hexagonally arranged pore structure in the [(001) plane] (see cross-sectional TEM in FIG. 7B). This d-spacing and pore diameter were estimated to be ˜91 Å and ˜45 Å respectively which matched well with the d-spacing shown in sample #2's XRD graph (see FIG. 4A). The sample #7 had a predicted and tested hexagonal geometry (see TEMs in FIGS. 7C-7D). In addition, the sample #20 had a tested hexagonal geometry even though the predicted geometry was lamellar (see TEMs in FIGS. 7E-7F). Lastly, the sample #8 had a predicted and tested cubic geometry (see TEMs in FIGS. 7G-7H).

The following discussion is provided to explain in more detail the materials and steps associated with making and testing sample #s 1-28. In addition, a discussion is provided below to describe a feature of the present invention where an ordered mesoporous carbon can be subsequently partially oxidized to form an activated carbon on which for example a catalyst can be dispersed and stabilized.

### Materials

The sample #s 1-28 were made with a surfactant (Pluronic™ F-127), a carbon precursor (phenolic resin) and an oil (butanol). In particular, the non-ionic surfactants used were PEOy-PPOx-PEOy tri block copolymers with x=106 and y=70 (Pluronic™ F127) and x=127 and y=50 (Pluronic™ F108) from BASF Inc. The carbon precursor used was 510D50 phenolic resin (Georgia Pacific) which had two different molecular weight (MW) species (GPC data, Mₙ ˜2800, 1060) (note: the 510D50 phenolic resin was not further purified). The mixture of the carbon precursor and H₂O contained 65% of phenolic resin and 35% H₂O at the cross-linked stage. The oil/cosurfactants used were butanol and p-xylene.

### Synthesis

In a typical synthesis, the PEOx-PPOy-PEOx triblock copolymer (e.g., 3.7 g Pluronic™ F127 (x=106, y=70)) was added to absolute ethanol (18% F127 in 20 ml of ethanol) and stirred with heat until the F127 triblock copolymer partially or fully dissolved in the ethanol. Then, a calculated amount of de-ionized water (1.4 ml) was added to the mixture resulting in the complete dissolution of the F127 triblock copolymer. Upon being stirred for a few minutes, the phenolic resin (3.0 ml of 510D50 phenolic resin) was added slowly into the mixture followed by vigorous stirring. The addition of the phenolic resin caused the solution to be hazy. Then, the butanol (1.5 ml) was added to the mixture followed by stirring. Finally, a calculated amount of 1.6N HCl (0.6 ml) was added to the mixture to completely dissolve the F127 triblock copolymer and help in the micelle formation. The resultant solution was then stirred at room temperature for 20-30 minutes and poured into crucibles for the drying and cross-linking steps.

### Drying and Cross-Linking:

The drying was carried out using one of five different processing conditions (a-e) in air, to optimize the condition for the self-assembly of the F127 triblock copolymer. The drying and cross-linking were carried out as follows:

a) Drying: The sample #s 1-5 were kept in a desiccator and heated from 50° C. to 90° C. at 0.5° C./min and soaked at 90° C. for 5 h then cooled to room temperature (RT) at 5° C./min. To perform the cross-linking, the sample #s 1-5 were kept in a desiccator and heated using the cycle identified in TABLE 2.

TABLE 2

| Initial Temp. | Final Temp. | Ramp | Soak time |
|---|---|---|---|
| (° C.) | (° C.) | (° C./min) | (h) |
| 50 | 80 | 0.1 | 3 |
| 80 | 95 | 0.1 | 3 |
| 95 | 110 | 0.1 | 2 |
| 110 | 125 | 0.1 | 2 |
| 125 | 150 | 10 | 1 |
| 150 | 50 | 5 | |

b) Drying: the sample #s 1-5 were kept in the oven and heated from 50° C. to 90° C. at 0.5° C./min and soaked at 90° C. for 5 h then cooled to RT at 5° C./min. Cross-linking: the samples #s 1-5 were kept in an oven (no desiccator) and heated using the cycle identified in TABLE 2.
c) Drying: the sample #s 1-28 were kept in an oven at 90° C. for 12 h. Cross-linking: the samples #s 1-28 were kept in an oven (no desiccator) and heated using the cycle identified in TABLE 2.
d) Drying: the sample #s 1-28 were kept in a hood (without a lid) to dry for 12 h. Cross-linking: the samples #s 1-28 were kept in an oven (no desiccator) and heated using the cycle identified in TABLE 2.
e) Drying: the sample #s 1-5 were kept in a hood (closed with lid) to dry for 5 days. Cross-linking: the samples #s 1-5 were kept in an oven (no desiccator) and heated using the cycle identified in TABLE 2.

The drying of sample #s 1-28 resulted in a viscous light orange liquid and the cross-linking cycle resulted in the formation of a dark orange-brown membrane. The cross-linked membranes were ˜1-2 mm in thickness and diameters ranging from 4-14 cm. Note: if desired the solutions nos. 1-28 (and other solutions) could be applied as coatings on top of substrates by dip coating, spin coating or casting etc. and then cross-linking them to form films which have a thickness in the range of nanometers to 1 mm.

### Carbonization:

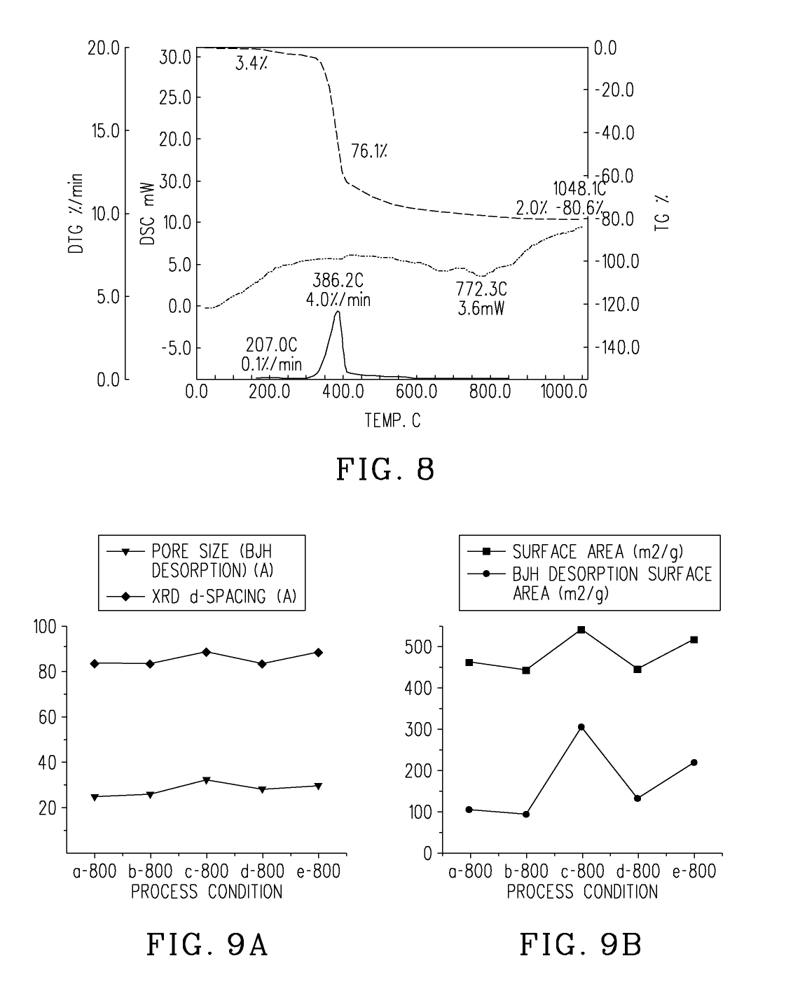

The resultant dark orange-brown membranes were carbonized in a nitrogen atmosphere by ramping the temperature at 1.7° C./min to reach 400° C. and then soaking them at that temperature for 3 h to remove the surfactant template followed by ramping the temperature again at 1° C./min to the carbonization temperature 800°-900° C. and soaking at that temperature for 3 h (FIG. 8 indicates that F127 surfactant template in sample #2 decomposed at 386° C.). This particular carbonization process yielded shiny black carbons. FIG. 8 also indicates thermal gravimetric analysis (TGA), differential scanning calorimetry (DSC) and differential thermal gravimetry (DTG) data associated with sample #2.

### Carbon Activation (Optional):

A carbon activation step involving chemical or physical e.g., CO₂ gas or the use of steam under 500-1000° C. post-carbonization could be performed to introduce more micro pores (<2 nm) into the ordered mesoporous carbons, resulting in ordered mesoporous carbons with both mesopore (2-50 nm) and micropore (<2 nm) formation (note: this step is discussed in greater detail below with respect to the activated carbon).

### Analysis of Drying Step:

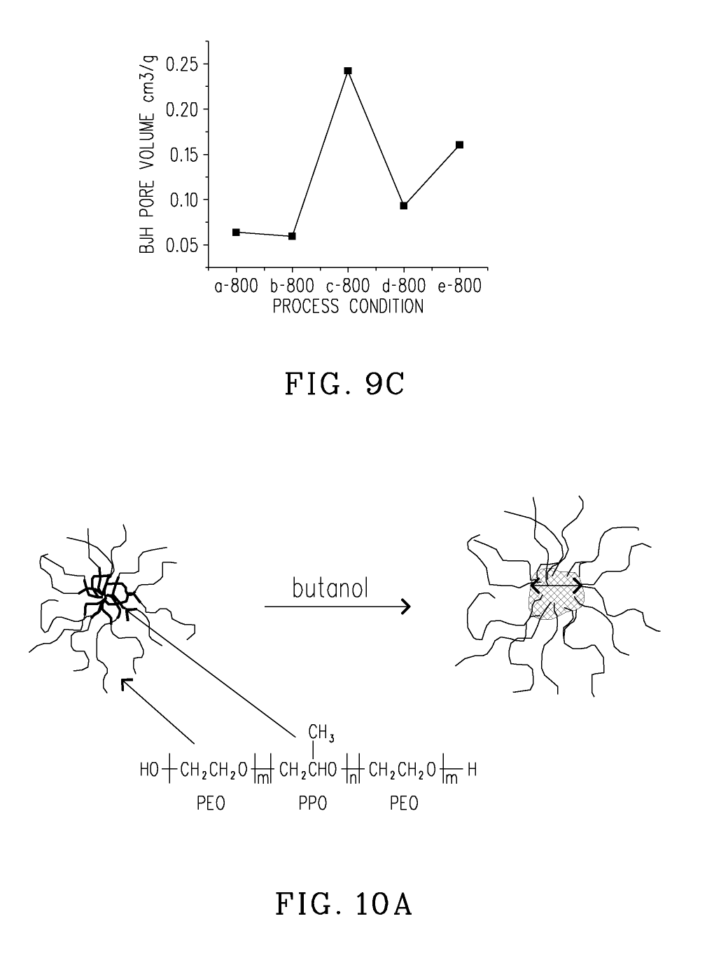

As discussed above, sample #s 1-28 where evaporated under the drying processes a-e. FIGS. 9A-9C show plots of pore properties vs. different processing conditions a-e for sample #2. The experimental data showed that the XRD d-spacing and Barrett-Joyner-Halenda (BJH) method pore size to be independent of the drying process a-e (see FIG. 9A). While, the experimental data associated with pore volume, the BJH surface area and the Brunauer-Emmett-Teller (BET) surface area showed some dependence with the drying processes a-e (see FIGS. 9B-9C). As can be seen, the drying processes c, d and e appeared to be favorable in terms of increasing surface area and pore volumes whereas the drying processes a and b appeared to give lower values. Therefore, more of the samples were prepared by using the drying processes c and d.

### Ethanol Solvent (not Needed):

The use of ethanol as a solvent for the self-assembly process (cross-linking process) was tested by carrying out experiments with different amounts of ethanol such as ethanol 20, 5 and 0 ml. In all three experiments, desirable ordered mesoporous carbons were obtained from sample #s 2 with process condition d suggesting that ethanol was not required under that particular condition for the self-assembly of the surfactant. This is beneficial in industrial applications where organic solvents (such as ethanol) are not a preferred solvent.

### Oil Phase:

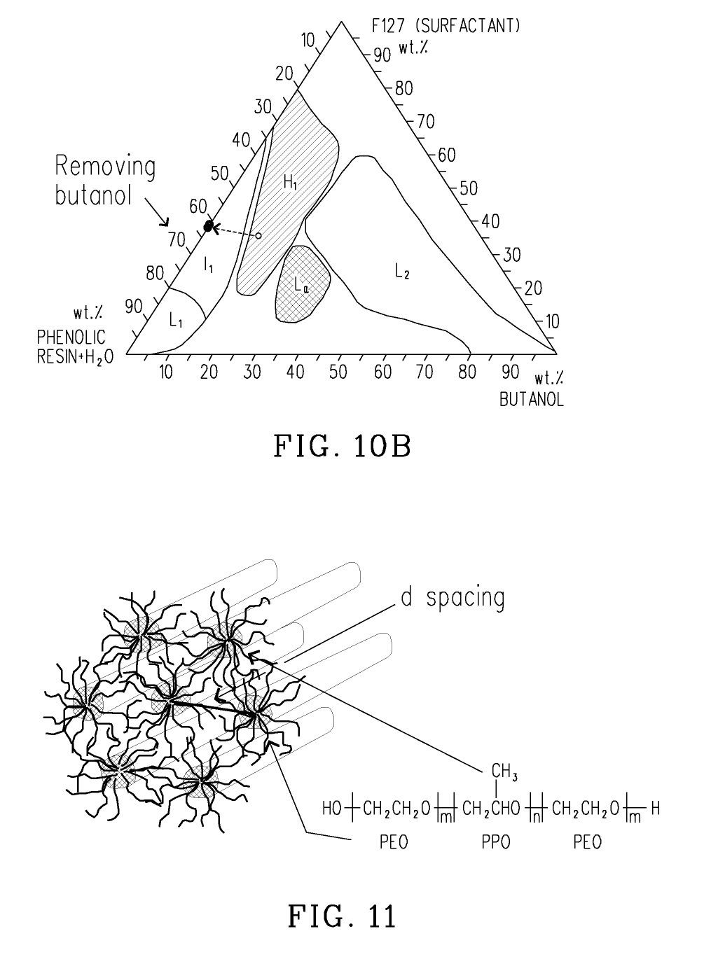

The oil (butanol) acts as a swelling agent for the PPO block within the F127 PEO-PPO-PEO surfactant system. Therefore, the amount of oil (butanol) that is used can help control the swelling of the micelle formed and also help control the pore size and pore mesostructure of the resulting ordered mesoporous carbons (see FIG. 10A). To better understand the role of butanol, two different experiments were conducted. In the first experiment, the butanol was removed from sample #2 which had a 2D hex structure (see TABLE 1 and 3). The removal of butanol from sample #2 resulted in the moving of the composition to a position associated with sample #s 11 or 12 which is resident within the cubic phase (see FIG. 10B). In both compositions of sample #s 11-12 the weight ratio of F127 surfactant to phenolic resin:water was kept the same. TABLE 3 shows the formulations for these compositions.

TABLE 3

| | | | | Phase | |
|---|---|---|---|---|---|
| | weight % | | | predicted | |
| sample | | phenolic | | phase | experimental |
| # | F127% | resin/water % | butanol % | diagram | phase |
| 2 | 35% | 53% | 12% | hex | Hex |
| 11 | 38% | 62% | 0% | cubic | Cubic |
| 12 | 38% | 62% | 0% | cubic | Cubic |

Note 1:
The water contains 1.6N HCl (acid) that is equal to approximately 0.2x surfactant weight.
Note 2:
The water used in formulation 12 did not contain an acid.

The role of butanol was also validated by a second experiment. In the second experiment, thermal desorption-gas chromatography/mass spectroscopy (TD-GC/MS) was used to ascertain the presence of butanol after the evaporation step which is associated with drying processes c and d. One set of sample #s 2 were evaporated at 90° C. for 18 h and the other set of sample #s 2 were evaporated at RT for 18 h. Then, the sample #s 2 where thermally desorbed at 25° C. and the offgassed volatile organic compounds (VOCs) were analyzed by GCMS to determine the butanol content at the respective drying processes c and d. The butanol was detected in both sets of sample #s 2. The peak area for the butanol released from the 90° C. set of sample #s 2 (peak area counts 815,154) was slightly less relative to the butanol released from the room temperature set of sample #s 2 (peak area counts 1,198,724). This suggests that butanol is present after the evaporation step was carried out at 90° C. as well as RT. The butanol amounts of the respective set of samples are listed in Table 4.

TABLE 4*

| | Butanol wt/sample wt |
|---|---|
| | PPM (ug/g) |
| As made | 45771 |
| 90 C., 18 h | 87.5 |
| RT, 18 h | 3490.2 |

*Note: several other types of oil phases in addition to butanol could be used if desired such as p-xylene, octane, hexadecane, hexanol, pentanol, mesitylene, etc.

### Carbon Precursor (Phenolic Resin) to Water Ratio:

Since, the water weight % is considered equivalent to carbon precursor+water weight % when using the well known and “new” phase diagrams, it seemed relevant to study different ratios between the carbon precursor:water solution. Therefore, several different sample #s 21-26 and 28 were made by varying the carbon precursor:water ratio approximately 9:1, 3:2, 2:3 and 1:4 at a particular weight %. TABLE 5 identifies the key data for this particular experiment.

TABLE 5

| | | | | | | | | | phase | |
|---|---|---|---|---|---|---|---|---|---|---|
| | | weight ratio | | | | weight % | | | | exp. |
| | | | | H₂0 + | | | Resin/H₂0 | | | phase |
| sample # | | | | 1.6N | | | (contains | | pred. | from |
| | Resin:H₂0 | F127 | RESIN | HCl | BUTANOL | F127% | acid) | Butanol % | phase | XRD |
| 21 | (3:2) | 1 | 0.98 | 0.70 | 0.32 | 33% | 56% | 11% | hex | hex |
| 22 | (9:1) | 1 | 1.64 | 0.16 | 0.32 | 32% | 58% | 10% | border | cubic |
| | | | | | | | | | of hex | |
| 23 | (3:2) | 1 | 0.98 | 0.81 | 0.11 | 34% | 62% | 4% | cubic | cubic |
| 27 | (2:3) | 1 | 0.78 | 1.14 | 0.11 | 33% | 63% | 4% | cubic | hex |
| 25 | (1:4) | 1 | 0.33 | 1.08 | 0.32 | 37% | 52% | 12% | hex | no |
| | | | | | | | | | | order |
| 26 | (3:2) | 1 | 0.98 | 0.54 | 0.32 | 35% | 53% | 11% | hex | hex |
| 28 | (2:3) | 1 | 0.92 | 1.30 | 0.88 | 24% | 54% | 21% | in b/w | hex |
| | | | | | | | | | hex/lam | |
| 24 | (3:2) | 1 | 1.37 | 0.92 | 0.88 | 24% | 55% | 21% | in b/w | cubic |
| | | | | | | | | | hex/lam | |

As can be seen, the formulation set of sample #s 21-22, and 25-26 which were from the 2D hex phase had their resin+water wt % respectively kept at ˜56-58% and 52-53% while their resin/water weight ratio was varied. The XRD data showed that when using 3:2 ratio the sample #21 retained the 2D hex phase but the phase changed to cubic when the ratio was changed to 9:1 for sample #22. Plus, the XRD data showed that when using the 3:2 ratio the sample #26 retained the 2D hex phase but the phase became disordered when the ratio was changed to 1:4 for sample #25.

### Role of H₂O:

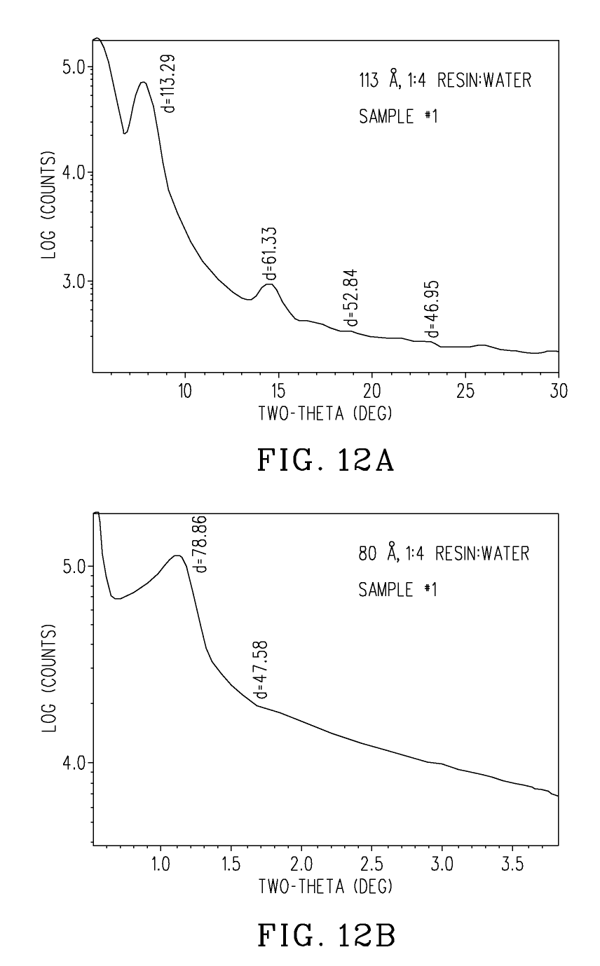

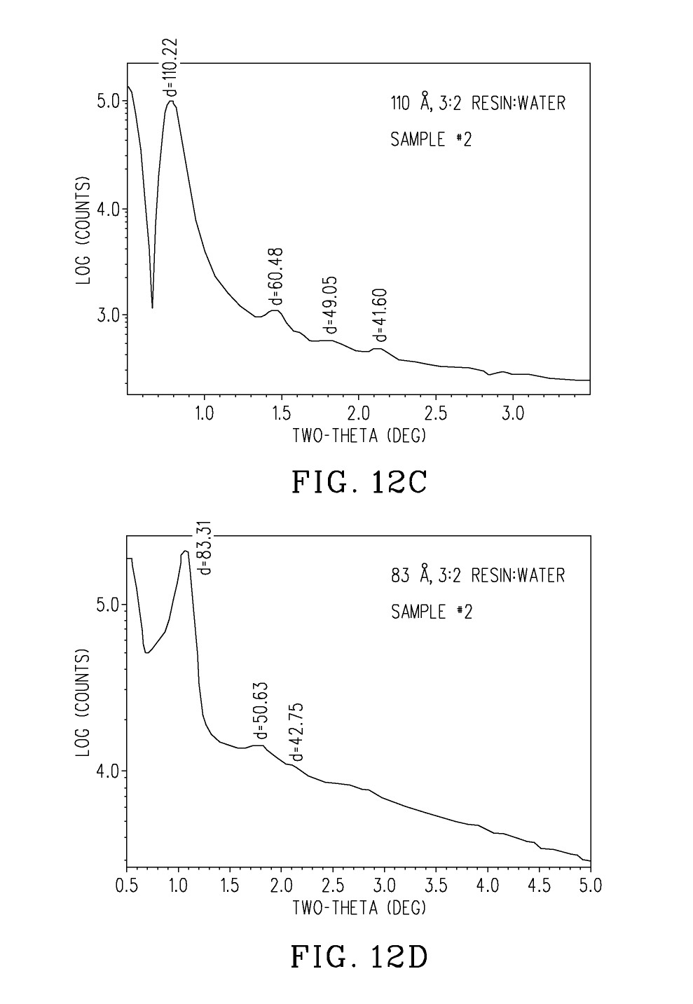

The water typically interacts with the PEO blocks within the PEO-PPO-PEO (e.g., Pluroincs™ F127) system and swells the phase containing the carbon precursor (see FIG. 11) (note 1: the water may contain a calculated amount of acid which can be approximately 0.2× the amount of the surfactant) (note 2: the acid helps in the micellular formation). Therefore, if water plays an important role in the self-assembly of the surfactant template then there should be a change in the d-spacing in the cross-linked material or the resultant carbons. FIGS. 12A-12B respectively show the XRD data indicating the d-spacing after cross-linking and the d-spacing after carbonization for sample #1 which had a phenolic resin:water ratio of 1:4. And, FIGS. 12C-12D respectively show the XRD data indicating the d-spacing after cross-linking and the d-spacing after carbonization for sample #2 which had a phenolic resin:water ratio of 3:2. As can be seen, the XRD data depicts no significant change in d-spacing either at the cross-linked stage or at the carbonized stage for sample #s 1 and 2 which suggests that the role of the water at this stage is not readily apparent.

### Ageing:

The ageing of the solution for sample #s 2 was also investigated. The resulting data indicated that if a certain formulation had a certain phase orientation at t=0, then the ageing of that solution (up to 4 weeks) did not affect the structure.

### Ageing of the Carbon Precursor:

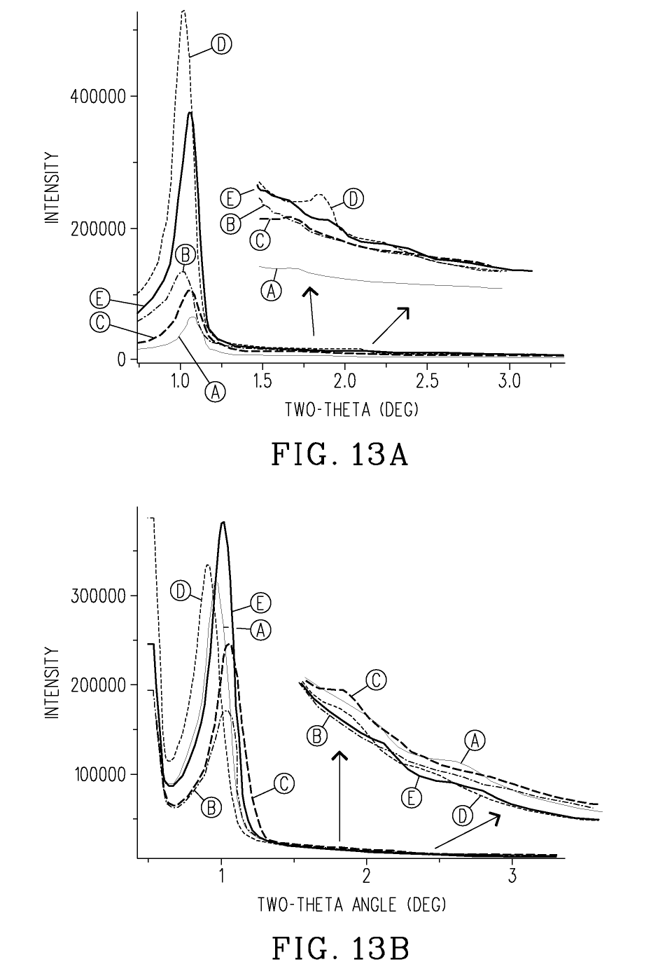

The effect of the shelf-life of the phenolic resin and the ageing of the carbon precursor solution was also studied. The Georgia Pacific 510D50 phenolic resin typically has a 6 month shelf-life if it is kept at 4° C. In this experiment, five compositions A-E having the same formulations were made to form a 2D hex phase except some compositions used a 10 month old phenolic resin (resin-old) and some of the compositions used a 3 month old phenolic resin (resin-new) that were kept at either 4° C. or −20° C. The new compositions all had a 2D hex order as shown in FIG. 13A. In this graph, the compositions with D-E phenolic resins kept at −20° C. had higher order peaks irrespective of the shelf-life. Plus, the composition D within the new phenolic resin kept at −20° C. had a very intense d(100) band. The compositions A-E were then aged for two-weeks (see FIG. 13B) and four-weeks (see FIG. 13C) followed by cross-linking and carbonization. In comparing these graphs, the two-theta changed +/−0.05 deg which affected the d(100) by +/−8 Å but the full width at half maximum (FWHM) had minimal changes which indicated that the ageing of these compositions (up to 4 weeks) did not affect the resulting structures. TABLES 6A-6C are legends which are respectively associated with FIGS. 13A-13C.

TABLE 6A

| composition # | phenolic resin | XRD data |
|---|---|---|
| A | resin-old 4° C. | d(100) 82 Å |
| B | resin-old 4° C. | d(100) 87 Å |
| C | resin-new 4° C. | d(100) 83 Å |
| D | resin-new −20° C. | d(100) 86 Å |
| E | resin-old −20° C. | d(100) 86 Å |

TABLE 6B

| composition # | phenolic resin | XRD data |
|---|---|---|
| A | resin-old 4° C. | d(100) 90 Å |
| B | resin-old 4° C. | d(100) 85 Å |
| C | resin-new 4° C. | d(100) 83 Å |
| D | resin-new −20° C. | d(100) 96 Å |
| E | resin-old −20° C. | d(100) 86 Å |

TABLE 6C

| composition # | phenolic resin | XRD data |
|---|---|---|
| A | resin-old 4° C. | d(100) 80 Å |
| B | resin-old 4° C. | d(100) 86 Å |
| C | resin-new 4° C. | d(100) 82 Å |
| E | resin-old −20° C. | d(100) 83 Å |

### Alternative Compositions:

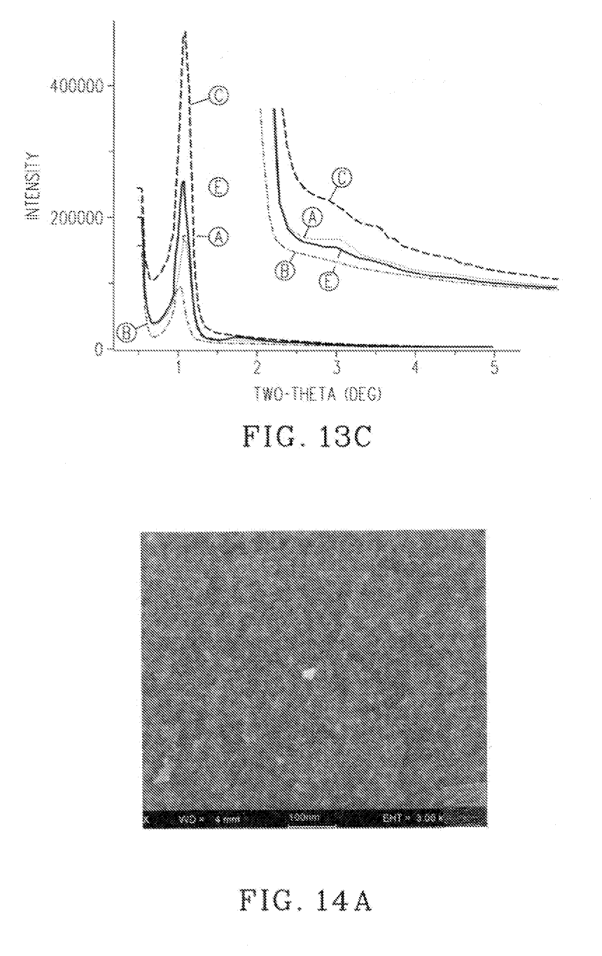

The compositions discussed above all included Pluronic™ F127 (surfactant), phenolic resin/H₂O (carbon precursor/H₂O) and butanol (oil). Alternative compositions can be used with different materials to vary the structure of the resulting ordered mesoporous carbons. For instance, these alternative compositions can use any combination of the following: (1) nonionic surfactants (e.g., PEO_{y}-PPOₓ-PEO_{y} tri block copolymer with different x, y values e.g., Pluronic™ P123_{x=20,y=70}, F108_{x=127,y=50}, F127_{x=106,y=70}, F88_{x=104,y=39}); (2) water-soluble carbon precursors (e.g., phenolic resin, thermosetting carbohydrates, polyvinylalcohol, resorcinol-formaldehyde, peptide amphiphiles, lipids or other biologically occurring materials); and (3) oils (e.g., butanol, pentanol, hexanol, octane, p-xylene, mesitylene, hexadecane, butyl acetate). As an example, a F108/phenolic resin/H₂O/butanol system has been used to synthesize a cubic geometry as can be seen by the SEM and TEM images respectively shown in FIGS. 14A and 14B.

### Pore Diameter and Pore Volume Distribution (PVD):

A porous structure of sample #2 which was made by using different drying conditions a-e was investigated by performing nitrogen adsorption/desorption isotherm measurements. TABLE 7 summarizes the results of this particular experiment:

TABLE 7

| | | | | | BJH | BJH | BbB-FHH | BbB-FHH |
|---|---|---|---|---|---|---|---|---|
| | | | | BJH | Desorp. | Adsorp. | Adsorp. | Desorp. |
| | | | BJH | Desorp. | Pore | pore | model | model |
| | | | Desorp. | Cum. Pore | Dia. | Dia. | Pore | Pore |
| | MP BET | SP BET | Cum. SA | Volume | (Mode) | (Mode) | Diam. | Diam. |
| sample # | (m2/g) | (m2/g) | (m2/g) | (cc/g) | (A) | (A) | (A) | (A) |
| 2 (a) | 460.8 | 484.4 | 103.82 | 0.0635 | 24.5 | 26.7 | — | — |
| 800 C. | | | | | | | | |
| 2 (b) | 443.5 | 465.6 | 93.61 | 0.0600 | 25.7 | 26.0 | — | — |
| 800 C. | | | | | | | | |
| 2 (c) | 541.8 | 560.2 | 305.16 | 0.2422 | 31.7 | 33.7 | 41 | 43 |
| 800 C. | | | | | | | | |
| 2 (d) | 446.3 | 468.1 | 133.37 | 0.0931 | 27.9 | 28.9 | 38 | 43 |
| 800 C. | | | | | | | | |
| 2 (e) | 519.0 | 539.6 | 218.88 | 0.1600 | 29.2 | 30.1 | 41 | 43 |
| 800 C. | | | | | | | | |

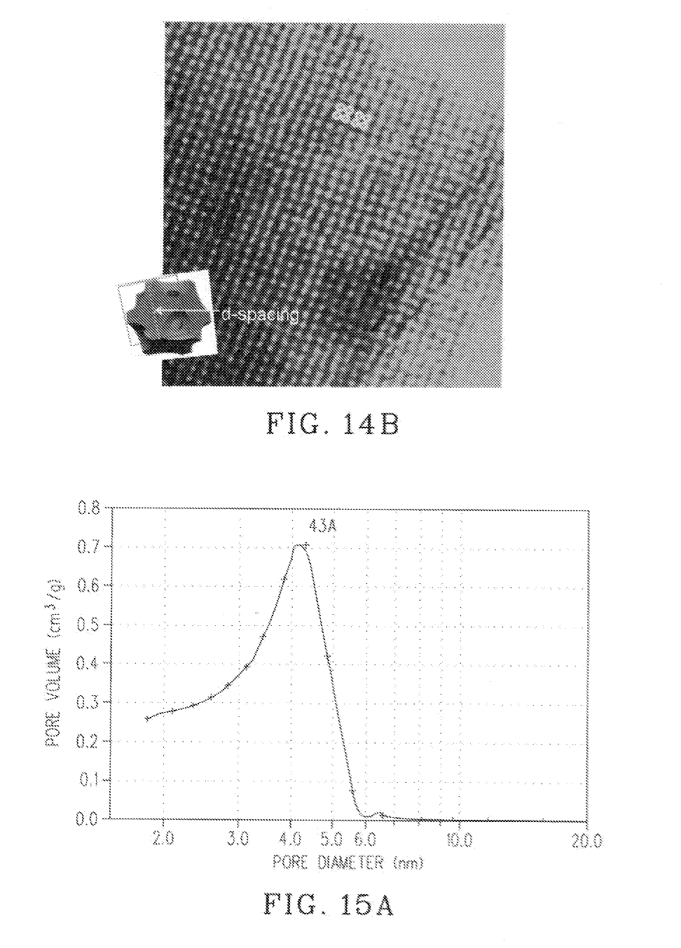

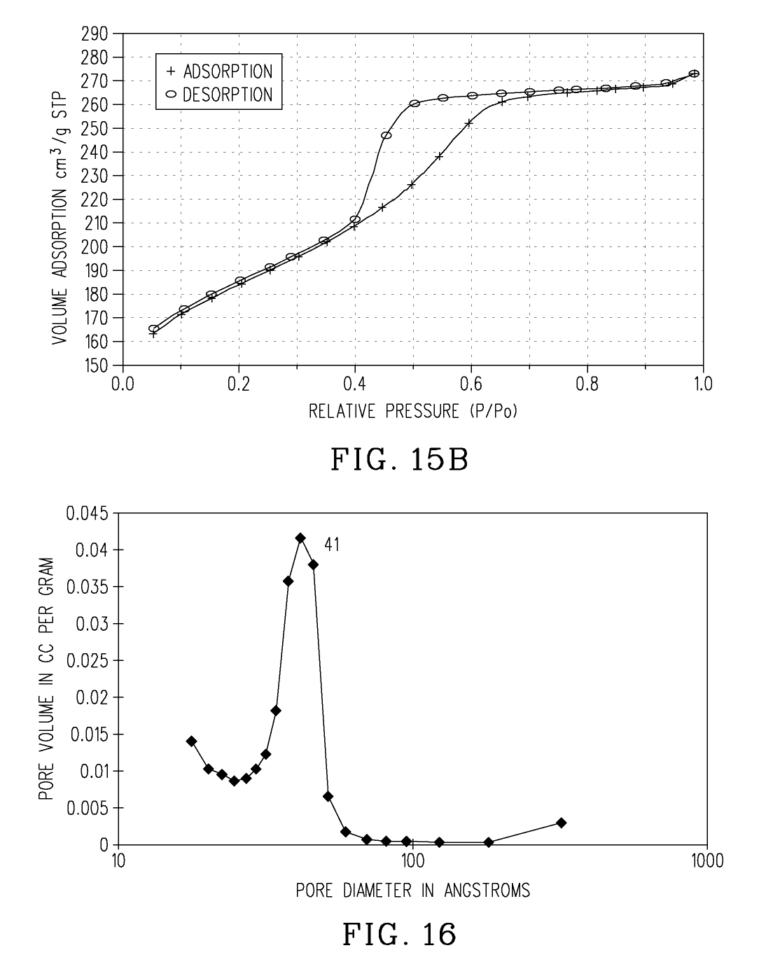

The pore diameters of the samples carbonized at 800° C. were estimated using the adsorption branch of the isotherm and fitting it to both BJH and BbB-FHH models (see columns 6, 7 and 8). The pore diameters obtained from the BbB-FHH model matched very well with the pore diameters which were calculated by using the TEM data shown in FIGS. 7A-7B. The nitrogen adsorption and desorption isotherm and the pore size distribution obtained using the calculated BJH and BbB-FHH models for the adsorption branch isotherm associated with sample #2 is shown in FIGS. 15A and 15B.

Referring back to FIG. 8, the TGA data indicated that the F127 surfactant template in sample #2 decomposed at a temperature below 400° C. while the thermosetting phenolic resin remained as the carbonaceous pores walls. The resulting ordered mesoporous carbon had a high BET surface area of 550-800 m²/g which included both mesopores (2-50 nm diameter) and micropores (<2 nm diameter). It was believed that the micropore volume could have been increased after 400° C. due to the generation of gases from the decomposition of the phenolic resin and this hypothesis was confirmed after performing an experiment that characterizes the surface area of ordered mesoporous carbons which where created at different temperatures. In addition, the increase in the micropore volume can be seen from the pore size distribution that was obtained (via the BJH model) using the adsorption branch in the graph shown in FIG. 16.

From the foregoing, it should be appreciated that one aspect of the present invention is related to a method of forming ordered mesoporous carbon from a formulation that includes and oil phase along with a surfactant phase and a water+carbon precursor phase. This method provides a much broader ability to access mesostructural phases and to control physical properties (e.g., pore volume, pore diameter) then when compared to a method employing only a surfactant phase and a water+carbon precursor phase. The manufacturing method 100a includes the following steps: (a) mixing a solution containing at least a predetermined amount of a solvent and the desired amounts of the surfactant, the carbon precursor, the water and the oil; (b) drying the solution; (c) cross-linking the solution to immobilize the water and form a pre-carbonized mesostructure phase (which includes a self-assembled organic template); and (d) carbonizing the pre-carbonized mesostructure phase to form the ordered mesoporous carbon (where the self-assembled organic template is dissolved to form the ordered mesoporous carbon). This method 100a can use an evaporation induced concentration of the surfactant/water and carbon precursor/oil phase to form an ordered mesostructure, and can be used to make thin films, coatings, free standing membranes, or powders.

It should also be appreciated that another aspect of the present invention is also related to a method 100b of formulating a composition which can be used to manufacture an ordered mesoporous carbon. This formulating method 100b includes the following steps: (1) selecting a surfactant/water/oil equilibrium phase diagram; (2) replacing a water phase label in the surfactant/water/oil equilibrium phase diagram with a carbon precursor+water phase label; and (3) using the surfactant/carbon precursor+water/oil equilibrium phase diagram as a guide to estimate how much surfactant, carbon precursor/water, and oil should be used to make the desired ordered mesoporous carbon. This particular formulation of the surfactant, carbon precursor/water solution and oil is what is used in the mixing step 102a of the manufacturing method 100a. Moreover, the present invention has several other features and advantages some of which are as follows:
The ordered mesoporous carbons made in accordance with the present invention have uniform pores, mesopore diameter (2-50 nm), high surface area, large pore volumes, and mechanical strength. These attributes can be controlled by adjusting the various process variables such as composition, solvents, humidity, stimulated cross-linking conditions (which is used to immobilize the water phase), pH, carbonizing conditions etc. . . .
The preferred composition used for the formation of ordered mesoporous carbons includes a surfactant, a carbon precursor/H₂O and an oil (or cosurfactant). This particular composition could be further manipulated to give carbons of different pore diameters by the addition of swelling agents and/or by changing oils (note: organic species such as mesitylene (1,3,5-trimethylbenzene, TMB) could be used if desired to increase pore size in the powdery forms of the ordered mesoporous carbons).
The cross-linking conditions described above introduces a thermosetting of the carbon precursor that is a primary factor for stabilizing the precarbonized mesostructure phase. However, the solvent(s) and humidity are other variables which can also be used to help assist in the stabilizing of the precarbonized mesostructure phase.
The preferred composition(s) described herein can be used for the formation of ordered mesoporous carbons having the form of monoliths, coatings or powders which can be used in applications associated with adsorption, separation, electrochemical double layer capacitors, catalysis, heavy metal sequestration etc. . . .
The manufacturing of the ordered mesoporous carbons described herein avoids the use of inorganic templates which gives more flexibility and control over the structure formation, reduces the number of preparation steps, reduces the cost involved in producing inorganic templates, and eliminates the need to use strong bases (or HF) to etch the inorganic template. This is desirable.
The manufacturing process of the present invention can use a prepolymerized carbon precursor which will result in less shrinkage during the cross-linking/thermosetting of the carbon precursor to form the precarbonized structure.
The surfaces of the ordered mesoporous carbons can if desired be chemically functionalized as well as charged by using electrostatics in a post-carbonization step.

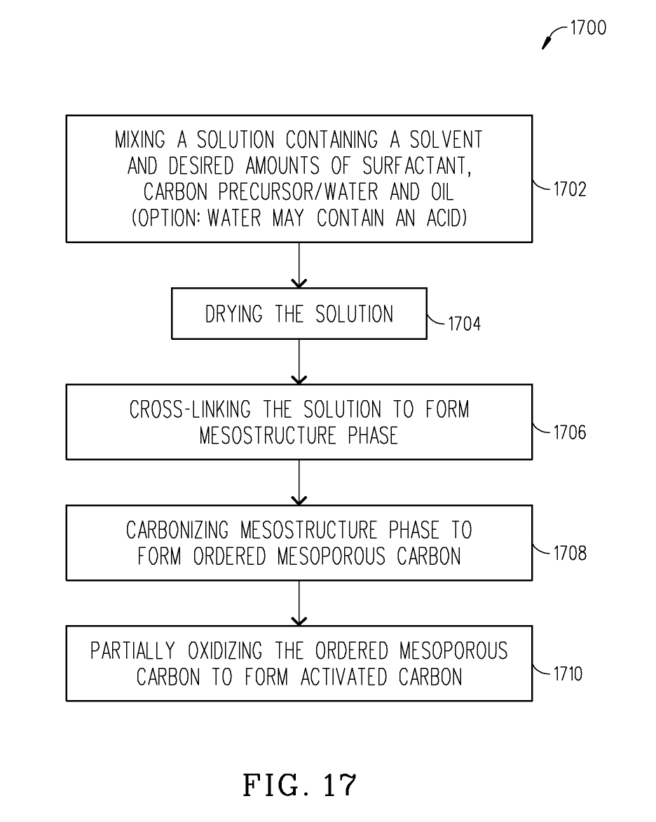

In yet another aspect of the present invention, the ordered mesoporous carbon can be partially oxidized to form an activated carbon on which for example a catalyst could be dispersed and stabilized. In addition, this activated carbon is an efficient ad/absorber of gaseous or dissolved species and thus could be used in a filtration application and if desired this filtration could be performed in combination with the stabilizing of a catalyst. Furthermore, this activated carbon could have a high Brunauer-Emmett-Teller (BET) surface area, exceeding 800 m²/g, and have a combination of micro and mesoporosity, <20 Å and 20-500 Å, respectively, which enables a high dispersion of catalysts at concentrations greater than 1-2 wt %. How this activated carbon can be made from a synthetic ordered mesoporous carbon in accordance with the present invention will be described in detail below with respect to FIGS. 17-21.

Referring to FIG. 17, there is a flowchart illustrating the various steps of a method 1700 for manufacturing an activated carbon in accordance with the present invention. The method 1700 includes the following steps: (a) mixing a solution containing a solvent and desired amounts of a non-ionic surfactant, a water-soluble carbon precursor/H₂O solution, and a water immiscible oil (cosurfactant) (step 1702) (option: the solution may contain a potassium compound such as, for example, potassium hydroxide, potassium acetate, potassium chloride, potassium nitrate, potassium sulfate or other potassium halides or the water may contain an acid such as, for example, a mineral acid, HCl, HNO₃, H₂SO₄, H₃PO₄); (b) drying the solution (step 1704); (c) cross-linking the solution to immobilize the water and form a pre-carbonized mesostructure phase (which includes a self-assembled organic template) (step 1706); (d) carbonizing the pre-carbonized mesostructure phase to form an ordered mesoporous carbon (this step can be carried out in an oxygen deprived atmosphere at a temperature>700° C. to control the surface area and to dissolve the self-assembled organic template) (step 1708); and (e) partially oxidizing the surface and at least a portion of the internal edges within channels/pores that open-up on the surface of the ordered mesoporous carbon so as to form the activated carbon (the ordered mesoporous carbon can be a film or it can be supported on a substrate while being partially oxidized) (step 1710). The activated carbon can be used in a variety of applications including, for example, as a filter, a membrane or a catalyst support (on which a catalyst can be dispersed and stabilized).

The activated carbon (which is made from a synthetic carbon source material) is a marked improvement over the traditional activated carbon because the manufacturing method 1700 leaves a structured carbon with an array of channels intact with a surface that has active sites thereon including internal edges of pores/channels which permit an ion exchange of active species or catalysts. In addition, the manufacturing method 1700 involves the use of a self-assembly structure which enables one to control the porosity and the surface area that will be present in the activated carbon. To control these features, one would select a well known surfactant/water/oil phase diagram and convert that diagram into a “new” surfactant/carbon precursor and water solution/oil equilibrium phase diagram which would be used as a guide to estimate a desired amount of surfactant, carbon precursor/water solution and oil which would be needed to make an activated carbon with the desired surface area and with the desired size and shaped pores (see the aforementioned formulation method 100b).

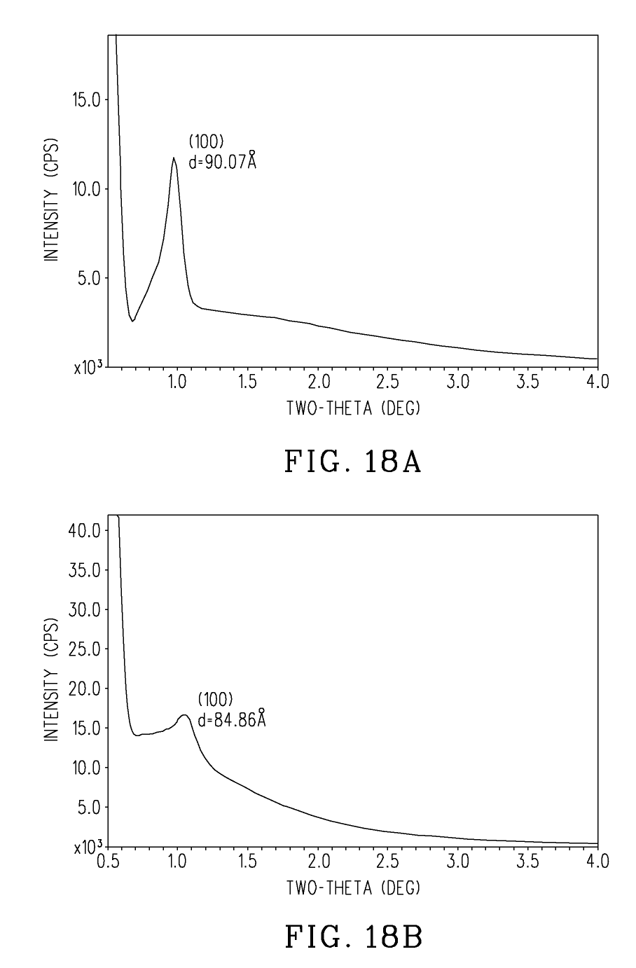

Referring to FIGS. 18-21, there are various diagrams, graphs and images which are used to help explain the results of several experiments that were conducted to test activated carbons which were made by the manufacturing method 1700 in accordance with one embodiment of the present invention. TABLE 8 identifies two formulations which were used to make two ordered mesoporous carbons that were then partially oxidized to form exemplary activated carbons (note: the two formulations correspond with sample nos. 2 and 5 which were discussed above with respect to TABLE 1).

TABLE 8*

| | weight % | | | | | |
|---|---|---|---|---|---|---|
| | | phenolic | | | phase | |
| | | resin/water | butanol | ethanol | predicted | exper. |
| sample# | F127% | (and acid) | % | (ML) | phase | phase |
| 2 | 35% | 53% | 12% | 20 | hex | hex |
| 5 | 21% | 55% | 24% | 12 | in b/w | cubic |
| | | | | | hex and | |
| | | | | | lamellar | |

*Note 1: Table 8 also identifies the predicted phase/orientation of sample nos. 2 and 5 (in view of the “new” surfactant/carbon precursor + water/oil equilibrium phase diagram shown in FIG. 3) and the actual phase/orientation in the resulting activated carbons.
** Note 2: If desired the initial composition can include a potassium compound. The potassium compound can increase the micro and or meso porosity as well as result in the in-situ activation of the carbon surface after carbonization. The potassium compound can include, for example, potassium hydroxide, potassium acetate, potassium chloride, potassium nitrate, potassium sulfate or other potassium halides (see detailed discussion below).

The following discussion is provided to explain in detail the materials and steps associated with making and testing the exemplary activated carbons (note: this description is very similar (except for the partial oxidation step 1710) to the description provided above with respect to sample nos. 1-28 but has been repeated so as to help describe the manufacturing and testing of the activated carbons).

### Materials

The sample #s 2 and 5 were made with a surfactant (Pluronic™ F-127), a carbon precursor (phenolic resin) and an oil (butanol). In particular, the non-ionic surfactant used was PEOy-PPOx-PEOy tri block copolymers with x=106 and y=70 (Pluronic™ F127) from BASF Inc. The carbon precursor used was 510D50 phenolic resin (Georgia Pacific). And, the oil/cosurfactant used was butanol.

### Synthesis (Step 1702)

The PEOx-PPOy-PEOx triblock copolymer (e.g., 3.7 g Pluronic™ F127 (x=106, y=70)) was added to absolute ethanol (18% F127 in 20 ml of ethanol) and stirred with heat until the F127 triblock copolymer had partially dissolved in the ethanol. Then, a calculated amount of de-ionized water (1.4 ml) was added to the mixture resulting in the dissolution of the F127 triblock copolymer. After being stirred for a few minutes, the phenolic resin (3.0 ml of 510D50 phenolic resin) was added slowly into the mixture followed by vigorous stirring. The addition of the phenolic resin caused the solution to be hazy. Then, the butanol (1.5 ml) was added to the mixture followed by vigorous stirring. Finally, a calculated amount of 1.6N HCl (0.6 ml) was added to the mixture to completely dissolve the F127 triblock copolymer. The resultant solution was stirred at room temperature for 20-30 minutes and then poured into crucibles for the drying and cross-linking steps.

### Drying and Cross-Linking (Steps 1704 and 1706):

The drying and cross-linking was carried out using a processing condition which was designed to help optimize the self-assembly of the F127 triblock copolymer. In particular, the drying was carried out by placing the sample nos. 2 and 5 in a desiccator and heating them from 50° C. to 90° C. at 0.5° C./min and then soaking them at 90° C. for 5 h and then cooling them to room temperature (RT) at 5° C./min. Thereafter, the sample nos. 2 and 5 were placed in a desiccator and cross-linked by heating them according to the heat cycle described with respect to the aforementioned TABLE 2.

The drying of sample nos. 2 and 5 resulted in the formation of viscous light orange liquids and the cross-linking resulted in the formation of dark orange-brown membranes. The cross-linked membranes were ˜1-2 mm in thickness and had diameters ranging from 4-14 cm. Note: if desired the solutions nos. 2 and 5 (and other solutions) could be applied as coatings on top of substrates by dip coating, spin coating or casting etc. and then cross-linking them to form films which have a thickness in the range of nanometers to 1 mm.

### Carbonization (Step 1708):

The resultant dark orange-brown membranes were carbonized in a nitrogen atmosphere by ramping the temperature at 1.7° C./min to reach 400° C. and then holding them at 400° C. for 3 h to remove the surfactant template followed by ramping the temperature again at 1° C./min to a temperature of 800° C. and soaking them at that temperature for 3 h. This particular carbonization process yielded shiny black carbons. FIG. 4A illustrates a low angle X-ray diffraction (XRD) graph that is associated with the shiny black ordered mesoporous carbon of sample no. 2 at this particular point in the manufacturing process 1700. As can be seen, the sample no. 2 had an intense well-resolved (100) peak at 96 Å with 2 higher order peaks of d(110) ˜52 Å and d(210) ˜37 Å at 1.7° and 2.4° two-theta respectively. This data is consistent with what was predicted by using the “new” surfactant/carbon precursor-water/oil equilibrium phase diagram of FIG. 3.

### Partial Oxidizing (Step 1710):

The carbonized membranes (ordered mesoporous carbon) of sample nos. 2 and 5 were then dispersed in 5M concentrated nitric acid and partially oxidized to form activated carbons. The result of this partially oxidizing step 1710 was to lower the surface pH of the activated carbons from ≧7 ph to <4 ph. This yielded a net negative charge on the surface and in the internal edges of channels/pores that open-up on the surface of the activated carbons which is particularly suitable for exchanging a cationic species, such as Pt(NH₃)₄²⁺, in a basic solution. Several of the activated carbons associated with sample no. 2 were tested in detail and the results which include low angle X-ray diffraction (XRD) graphs, wide angle XRD graphs, and a transmission electron micrograph (TEM) are discussed next with respect to FIGS. 18-21.

Referring to FIGS. 18A-18B, there are shown two low angle (0.5-5°) XRD graphs which were obtained after testing two Pt-exchanged activated carbons (sample no. 2). In particular, FIG. 18A shows the low angle XRD data obtained from the first activated carbon (sample no. 2) that underwent a redox activation of 30 min in concentrated HNO₃ before it was used to exchange Pt. And, FIG. 18B shows the low angle XRD data obtained from the second activated carbon (sample no. 2) that underwent a redox activation of 60 min in concentrated HNO₃ before it was used to exchange Pt. Due to the Pt exchange and that the background at low angle is quite high only the most intense (100) peak can be seen in FIGS. 18A and 18B (compare to FIG. 4A in which the un-activated ordered mesoporous carbon (sample no. 2) can be seen to have a 2D hexagonal geometry (p6m space group) because of the d-spacings of 1:√3:√7 which are indexed as (100), (110) and (210) reflections).

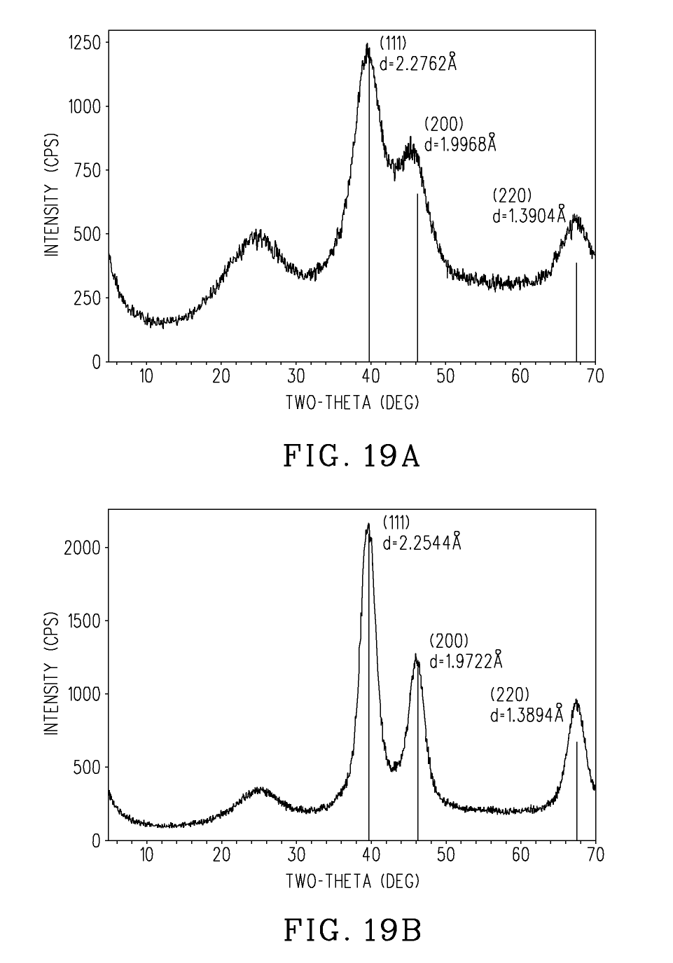

Referring to FIGS. 19A-19B, there are shown two wide angle (5-70°) XRD graphs which were obtained after testing two Pt-exchanged activated carbons (sample no. 2). In particular, FIG. 19A shows the wide angle XRD data obtained from the first activated carbon (sample no. 2) that underwent a redox activation of 30 min in concentrated HNO₃ before it was used to exchange Pt (where the Pt²⁺ solution concentration was 0.1-0.05M). And, FIG. 19B shows the wide angle XRD data obtained from the second activated carbon (sample no. 2) that underwent a redox activation of 60 min in concentrated HNO₃ before it was used to exchange Pt (where the Pt²⁺ solution concentration was 0.05M). The vertical lines in these graphs depict the Pt peaks/bands with their corresponding 2-theta value (Å) and miller indices (hkl).

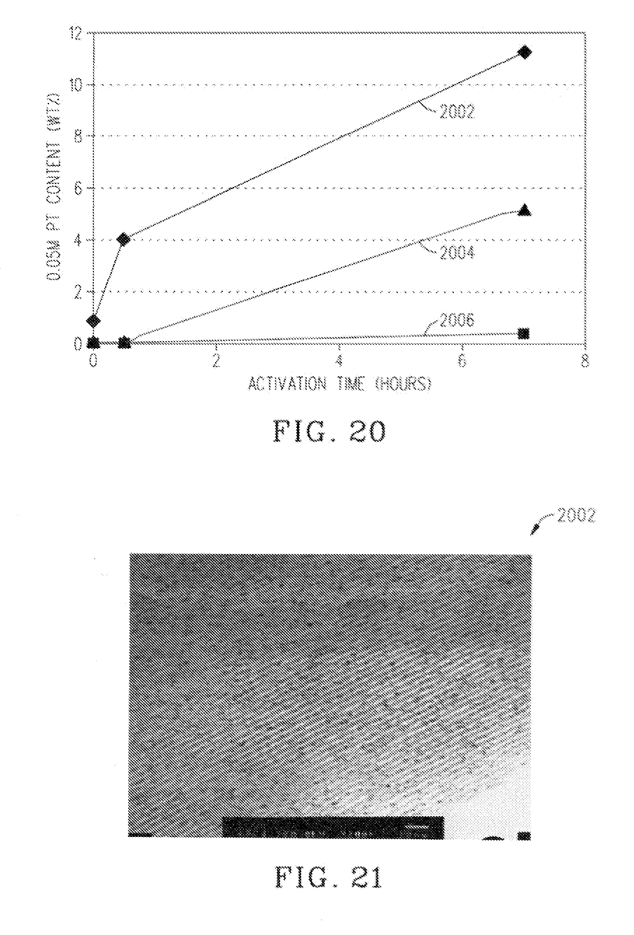

Referring to FIG. 20, there is a graph which shows the effect that a carbon self-assembly structure can have on the ion exchange process after undergoing a redox activation in nitric acid. The graph indicates that an activated carbon 2002 (sample no. 2) which had hexagonal channel structures (2D-Hex, 4 nm diameter channels) was more susceptible to activation and ion exchange than an activated carbon 2004 (sample no. 5) which had a cubic structure or a disordered activated carbon 2006. In addition, the graph indicates that after seven hours of redox activation, the 2D-Hex activated carbon 2002 (sample no. 2) exchanged more than twice the amount of Pt than the cubic structured carbon 2004 (sample no. 5) and more than 30 times the amount of Pt that was exchanged by the disordered activated carbon 2006. FIG. 21 is a TEM of a redox activated (in 6% H₂/N₂ forming gas ramping at 60° C./hour to 500° C. and holding at this temperature for 3 hours) and Pt-exchanged activated carbon 2002 (sample no. 2). The TEM shows that the Pt crystallites (dark spots which are ˜2-4 Å in diameter) are ordered along the hexagonal channels in the activated carbon 2002 (note: that the Pt exchange sites are parallel or appear parallel to the channel length, and that the exchanged Pt ions are ordered along this dimension).

### Alternative Partial Oxidizing (Step 1710):

The partially oxidizing step 1710 can also be performed by using a chemical process with a redox solution which contains an oxidizing agent that is different than nitric acid. For instance, the partially oxidizing step 1710 can be performed by using a chemical process with a redox solution which contains hydrogen peroxide, a peroxide-bearing compound, an oxidizing halogenic compound, a mineral acid and/or and a phosphoric acid. In addition, the use of a temperature controlled alkali solution, such as NaOH, during the partially oxidizing step 1710 can be helpful in not only activating the ordered mesoporous carbon but also in increasing the surface area on the ordered mesoporous carbon. Alternatively, the partially oxidizing step 1710 can be performed by using a thermal process with steam, carbon dioxide, oxygen, or with a combination of these and/or other gaseous species in an inert atmosphere. In either case, the partially oxidizing step 1710 can be performed to influence the surface area, to introduce micro pores (<2 nm) and/or to control the size of the meso pores (2-50 nm)) of the resulting activated carbon.

### Alternative Initial Composition

The initial composition of the non-ionic surfactant, the water-soluble carbon precursor/H₂O solution, and the water immiscible oil (cosurfactant) can further include a potassium compound (see note 2 in TABLE 8). The addition of the potassium compound can be advantageous since it can increase the micro and or meso porosity as well as result in the in-situ activation of the carbon surface after carbonization (i.e., the partial oxidation step 1710 may not need to be performed). The potassium compound can include, for example, potassium hydroxide, potassium acetate, potassium chloride, potassium nitrate, potassium sulfate or other potassium halides.

The potassium compound can be present in the carbon precursor at a level greater than 1%, preferably 2% to 50% and more preferably 2%-25%. Plus, the ratio of the potassium compound should be included in the water phase and the concentration of the potassium compound should be sufficiently diluted so as to not interfere with the organization of the surfactant during the processing steps 1704 and 1706. After the product has been carbonized in step 1708, it is then typically washed with warm water to remove any residual potassium compounds. The washing could be continued until the pH of the wash water is neutral. This process leaves porosity in the resulting activated carbon and eliminates the need for an additional activation/partial oxidizing step 1710 to make a high surface area activated carbon.

### Ion Exchange and Catalyst

As discussed above, the activated carbons of the present invention are particularly suitable for exchanging a cationic species, such as Pt(NH₃)₄²⁺, in a basic solution (see FIGS. 18-21). It should also be noted that the new activated carbons can be catalyzed in any number of ways including (for example):

1. Metal catalysts can be introduced into the new activated carbons using cationic ion exchange. The metal catalysts can be alkali, alkaline earth, transition and/or noble metals. More preferred are catalyst metals such as Pt, Pd, Rh Ag, Au, Fe, Re Sn, Nb, V, Zn, Pb, Ge, As, Se, Co, Cr. Ni, Mn, Cu, Li Mg, Ba, Mo, Ru, Os, Ir, Ca, Y, or any combination of these. In fact, the structure of the new activated carbon allows for a much higher weight percent ion exchange of these metals and results in very high dispersions of small catalyst nano-particles when compared to traditional activated carbons.

2. The new activated carbon can be catalyzed by using ion exchange of catalyst precursors including alkali metals, alkali earth metals, noble metals or transition metals.

3. The new activated carbon can be catalyzed by chemisorption when using ammonium chloroplatinate (for example).

4. The new activated carbon can be catalyzed by using pH controlling agents such as bases and acids to affect the solubility of the precursors, the surface charge and the surface charge density.

5. The new activated carbon can be catalyzed by using tetraamineplatinum(II)nitrate.

6. The new activated carbon can be catalyzed by using anionic exchange to form S, P, phosphates, sulfates, borates and other anions on the surface.

7. The new activated carbon can be catalyzed by using cationic or anionic transition metal or other salts at a controlled and compatible pH to affect ion exchange chemisorption and form S, P, phosphates, sulfates or borates on the surface.

### Alternative Processing Steps

The following is a list of several different exemplary processing steps that can be performed to make an ordered mesoporous carbon or activated carbon in accordance with the present invention:

1. The ordered carbon cross-linked resin precursor can be treated at elevated temperatures>30° C. and for >15 min in an inert gas and/or with activating gases containing S, N, C, or other gases to yield a partially oxidized mesoporous carbon with a high surface area>600 m2/g.

2. The ordered carbon cross-linked resin precursor can be treated at elevated temperatures>30° C. and for >15 min in nitrogen to yield a mesoporous carbon.

3. The ordered mesoporous carbon can directly treated at elevated temperatures>30° C. and for >15 min in an oxidizing or partially oxidizing atmosphere to yield a very high surface area mesoporous carbon.

4. The mesoporous carbon can be chemically activated with an oxidizing agent such as a mineral acid, HCl, HNO₃, H₂SO₄, or other acids such as, CH₃COOH, or bases, such as NH₄OH, phenylamine, or other elements at temperatures<110° C. for >15 min.

Although multiple embodiments of the present invention have been illustrated in the accompanying Drawings and described in the foregoing Detailed Description, it should be understood that the invention is not limited to the disclosed embodiments, but is capable of numerous rearrangements, modifications and substitutions without departing from the spirit of the invention as set forth and defined by the following claims.

1. A method for manufacturing an ordered mesoporous carbon, said method comprising the following steps:
mixing a solution which contains a solvent and a predetermined amount of a surfactant, a carbon precursor/water solution, and an oil;
drying the solution;
cross-linking the solution to immobilize the water and form a pre-carbonized mesostructure phase; and
carbonizing the pre-carbonized mesostructure phase to remove a self-assembled surfactant template from therein so as to form the ordered mesoporous carbon.

2. The method of claim 1, wherein said water contains a desired amount of an acid.

3. The method of claim 1, further comprising the steps of:
selecting a surfactant/water/oil equilibrium phase diagram;
replacing a water phase label in the surfactant/water/oil equilibrium phase diagram with a carbon precursor and water phase label; and
using the surfactant/carbon precursor and water solution/oil equilibrium phase diagram as a guide to calculate the predetermined amount of the surfactant, the carbon precursor/water solution, and the oil which should be used to make the ordered mesoporous carbon.

4. The method of claim 3, further comprising the step of using the surfactant/carbon precursor and water solution/oil equilibrium phase diagram to select a desired orientation of the ordered mesoporous carbon.

5. The method of claim 1, further comprising the step of carbon activating the ordered mesoporous carbon.

6. The method of claim 1, wherein said mixing step is performed without using ethanol as the solvent.

7. The method of claim 1, wherein said ordered mesoporous carbon is used to make a thin film, a coating, a free standing membrane, or a powder.

8. The method of claim 1, further comprising the step of partially oxidizing a surface and at least a portion of internal edges within channels that open-up on the surface of the ordered mesoporous carbon so as to form an activated carbon.

9. The method of claim 8, wherein said partially oxidizing step further includes a step of thermally treating the ordered mesoporous carbon to form the activated carbon.

10. The method of claim 9, wherein said thermally treating step is performed in an inert atmosphere containing steam, carbon dioxide and oxygen or a combination thereof.

11. The method of claim 8, wherein said partially oxidizing step further includes a step of chemically treating the ordered mesoporous carbon to form the activated carbon.

12. The method of claim 11, wherein said chemically treating step is performed by using an oxidizing agent including hydrogen peroxide, a peroxide-bearing compound, an oxidizing halogenic compound, a mineral acid, nitric acid, phosophoric acid and/or an alkali solution.

13. The method of claim 1, wherein said surfactant is a non-ionic surfactant including a PEO_{y}-PPOₓ-PEO_{y} tri block copolymer.

14. The method of claim 1, wherein said carbon precursor is a water-soluble carbon precursor including a phenolic resin, a thermosetting carbohydrate, a polyvinylalcohol, a resorcinol-formaldehyde peptide amphiphile or a lipid.

15. The method of claim 1, wherein said oil is butanol, pentanol, hexanol, p-xylene, mesitylene, hexadecane, butyl acetate or octane.
